(19) United States
(12) Patent Application Publication
(10) Pub. No.: US 2026/0170835 A1
(43) Pub. Date: Jun. 18, 2026

(54) MONITORING SYSTEM, MONITORING APPARATUS, MONITORING METHOD, AND NON-TRANSITORY COMPUTER-READABLE STORAGE MEDIUM

(71) Applicant: NEC CORPORAITION, Minato-ku, Tokyo (JP)

(72) Inventors: Takami SATO, Tokyo (JP); Soma SHIRAISHI, Tokyo (JP); Katsuhiko TAKAHASHI, Tokyo (JP); Tomokazu KANEKO, Tokyo (JP)

(73) Assignee: NEC Corporation, Minato-ku, Tokyo (JP)

(21) Appl. No.: 18/710,691

(22) PCT Filed: Mar. 8, 2022
(86) PCT No.: PCT/JP2022/009988

§ 371 Date: May 16, 2024

(51) Int. Cl. G06V 20/52; G06Q 20/20; G06T 7/70; G06V 40/20

(52) U.S. Cl. CPC G06V 20/52; G06Q 20/208; G06T 7/70; G06V 40/28; G06V 2201/07

(57) ABSTRACT

A monitoring apparatus (100) includes an image acquisition unit (102) that acquires an image including a product display region being present within a predetermined range from a settlement apparatus being operated by a customer and including a product registration function and a settlement function, a detection unit (104) that detects that a customer picks up a product from the product display region by processing the image, and a processing unit (106) that, when the detection unit (104) detects that the customer picks up the product, causes an output unit to output information for urging registration processing for the product in a case of before completion of accounting processing, and causes a storage unit to store customer identifiable information in a case of after completion of accounting processing.

This application is a National Stage Entry of PCT/JP2022/009988 filed on March 8. 2022, the contents of all of which are incorporated herein by reference, in their entirety.

### TECHNICAL FIELD

The present invention relates to a monitoring system, a monitoring apparatus, a monitoring method, and a storage medium.

### BACKGROUND ART

In recent years, due to factors such as need to solve a labor shortage and a suppress labor cost, a retailer or the like has been forced to reduce the number of employees. Thus, a settlement apparatus that enables a customer him/herself to execute product registration and settlement processing, that is, a so-called self-checkout apparatus has been widely used.

However, because a customer operates the self-checkout apparatus by his/herself, there is a risk of a fraud by a customer, and hence a measure to counteract a fraudulent action is required.

Patent Document 1 describes an example of a settlement system that implements a measure to counteract such a fraudulent action. The settlement system includes a clerk registration unit that registers a product by a clerk, a settlement unit that is operated by a customer and performs settlement, an image capturing unit that captures an image of an operation state of a customer when being performed settlement by the settlement unit, a display unit that displays an image capturing result from the image capturing unit, a state control unit that controls a first state in which a product is mainly registered by the clerk registration unit and another state being a second state, and a display control unit that changes control of display by the display unit according to a state being controlled by the state control unit. With this configuration, in the settlement system described in Patent Document 1, a series of registration actions of a customer that include an action of picking up a product from a shopping basket, an action of registering the product, and an action of putting the registered product into the shopping basket can be displayed on a wide-area image capturing screen. In this manner, in a full self-service mode, it is possible to make a customer aware of being monitored, and thereby achieve a preventive effect against a fraudulent action relating to settlement.

Further, Patent Documents 2 to 4 describe a system that executes product registration automatically by determining a product picked up from a display shelf and adding the product to a purchase list of an associated customer. In any of the patent documents, a product picked up from a display shelf and a customer who picks up the product are associated with each other by using an image captured by a camera, detection data of a weight sensor, or the like, by detecting, from a position or an action of the customer, picking up the product from the display shelf, or tracking movement of the customer within a store, and thus automatic settlement is enabled.

### RELATED DOCUMENTS

### Patent Documents

Patent Document 1: Japanese Patent Application Publication No. 2021-157420
Patent Document 2: Japanese Patent Application Publication No. 2021-108208
Patent Document 3: Japanese Patent Application Publication No. 2020-115261
Patent Document 4: International Patent Publication No. WO2021/125357

### SUMMARY OF INVENTION

### Technical Problem

The techniques described in Patent Documents 2 to 4 relate to a technique for executing product registration and settlement automatically. Thus, in the techniques described in Patent Documents 2 to 4, a customer is not required to execute product registration or settlement processing, and hence accounting omission or a fraud during product registration or settlement processing by a customer does not occur. Further, the technique described in Patent Document 1 is provided to prevent a fraudulent action relating to settlement, for example, an action of falsely or by misrecognition declaring a higher amount of money being deposited. Thus, in the technique described in Patent Document 1, registration omission at a time of product registration cannot be prevented.

In view of this, the present inventor focuses on a problem that may be frequently caused, where accounting omission of a product is caused intentionally or unintentionally after a customer takes the product displayed in a periphery of a settlement apparatus that is operated by a customer and includes functions of product registration and settlement.

In view of the above-mentioned problem, one example of an object of the present invention is to provide a monitoring system, a monitoring apparatus, a monitoring method, and a storage medium that solve a problem of accounting omission of a product displayed in a periphery of a settlement apparatus that is operated by a customer and includes functions of product registration and settlement.

### Solution to Problem

According to one aspect of the present invention, there is provided a monitoring apparatus including:
an image acquisition unit that acquires an image including a product display region being present within a predetermined range from a settlement apparatus being operated by a customer and including a product registration function and a settlement function;
a detection unit that detects that a customer picks up a product from the product display region by processing the image; and
a processing unit that, when the detection unit detects that the customer picks up the product,
   causes an output unit to output information for urging registration processing for the product in a case of before completion of accounting processing, and
   causes a storage unit to store customer identifiable information in a case of after completion of accounting processing.

According to one aspect of the present invention, there is provided a monitoring system including:
a monitoring apparatus;
a settlement apparatus being operated by a customer and including a product registration function and a settlement function; and
a camera configured to generate an image including a product display region being present within a predetermined range from the settlement apparatus, wherein
the monitoring apparatus includes
   an image acquisition unit that acquires the image,
   a detection unit that detects that a customer picks up a product from the product display region by processing the image, and
   a processing unit that, when the detection unit detects that the customer picks up the product,
      causes an output unit to output information for urging registration processing for the product in a case of before completion of accounting processing, and
      causes a storage unit to store customer identifiable information in a case of after completion of accounting processing.

According to one aspect of the present invention, there is provided a monitoring method including,
by one or more computers:
   acquiring an image including a product display region being present within a predetermined range from a settlement apparatus being operated by a customer and including a product registration function and a settlement function;
   detecting that a customer picks up a product from the product display region by processing the image; and,
   when it is detected that the customer picks up the product,
      causing an output unit to output information for urging registration processing for the product in a case of before completion of accounting processing, and
      causing a storage unit to store customer identifiable information in a case of after completion of accounting processing.

According to one aspect of the present invention, there is provided a computer-readable storage medium configured to store a program for causing a computer to execute:
a procedure of acquiring an image including a product display region being present within a predetermined range from a settlement apparatus being operated by a customer and including a product registration function and a settlement function;
a procedure of detecting that a customer picks up a product from the product display region by processing the image; and,
when it is detected that the customer picks up the product in the procedure of detecting,
   a procedure of causing an output unit to output information for urging registration processing for the product in a case of before completion of accounting processing, and
   a procedure of causing a storage unit to store customer identifiable information in a case of after completion of accounting processing.

Note that, according to another aspect of the present invention, there may be provided a program causing at least one or more computers to execute the method according to the one aspect, and there may be provided a computer-readable storage medium configured to store such a program. The storage medium includes a non-transitory and tangible medium.

Note that, any combination of the above-mentioned constituent elements, and a matter acquired by converting an expression of the present invention between the method, the apparatus, the system, the storage medium, the computer program, and the like are also effective as an aspect of the present invention.

Further, various constituent elements of the present invention are not necessarily independent entities; a plurality of constituent elements may be formed as a single member, one constituent element may be formed from a plurality of members, a certain constituent element may be part of another constituent element, or a part of a certain constituent element and a part of another constituent element may overlap with each other, among other possibilities.

Further, a plurality of procedures are described in order in the method and the computer program according to the present invention, and the order thereof in the description is not intended to limit the order of executing the plurality of procedures. Thus, when the method and the computer program according to the present invention are executed, the order of the plurality of procedures can be changed within a range that does not affect the contents.

Moreover, the plurality of procedures of the method and the computer program according to the present invention are not limited to being executed at distinct timing. Therefore, it is acceptable that a certain procedure occurs during execution of another procedure, some or all of execution timing of a certain procedure and execution timing of another procedure overlap with each other, and the like.

### Advantageous Effects of Invention

According to one aspect of the present invention, there are provided a monitoring system, a monitoring apparatus, a monitoring method, and a storage medium that solve a problem of accounting omission of a product displayed in a periphery of a settlement apparatus that is operated by a customer and includes functions of product registration and settlement.

### BRIEF DESCRIPTION OF THE DRAWINGS

FIG. 1 It is a diagram illustrating an overview of a monitoring apparatus according to an example embodiment.

FIG. 2 It is a flowchart illustrating an operation example of the monitoring apparatus according to the example embodiment.

FIGS. 3A and 3B They are diagrams each illustrating an example of an image acquired by the monitoring apparatus.

FIG. 4 It is a diagram schematically illustrating a system configuration of a monitoring system according to the example embodiment.

FIG. 5 It is a block diagram illustrating a hardware configuration of a computer that achieves the monitoring apparatus.

FIGS. 6A and 6B They are diagrams each illustrating a data structure example of a detection result according to the example embodiment.

FIG. 7 It is a functional block diagram illustrating a logical configuration example of the monitoring apparatus according to the example embodiment.

FIG. 8 It is a diagram illustrating a data structure example of a detection result according to the example embodiment.

FIG. 9 It is a flowchart illustrating an operation example of the monitoring apparatus according to the example embodiment.

FIG. 10 It is a flowchart illustrating an operation example of the monitoring apparatus according to the example embodiment.

FIG. 11 It is a flowchart illustrating an operation example of the monitoring apparatus according to the example embodiment.

FIG. 12 It is a functional block diagram illustrating a logical configuration example of the monitoring apparatus according to the example embodiment.

FIG. 13 It is a flowchart illustrating an operation example of the monitoring apparatus according to the example embodiment.

FIG. 14 It is a diagram illustrating a data structure example of a detection result that stores a decision flag.

FIG. 15 It is a functional block diagram illustrating a logical configuration example of the monitoring apparatus according to the example embodiment.

FIG. 16 It is a flowchart illustrating an operation example of the monitoring apparatus according to the example embodiment.

FIGS. 17A and 17B They are diagrams for describing a registration method performed by a registration unit.

FIG. 18 It is a flowchart illustrating an operation example of the monitoring apparatus according to the present example embodiment.

FIG. 19 It is a flowchart illustrating an operation example of the monitoring apparatus according to the present example embodiment.

FIG. 20 It is a diagram illustrating a procedure example of product registration processing and settlement processing by a self-checkout terminal.

FIG. 21 It is a diagram illustrating an operation example in a first example.

FIG. 22 It is a diagram illustrating an operation example in a second example.

FIG. 23 It is a diagram for describing output timing of a message.

FIG. 24 It is a diagram for describing output timing of a message.

FIG. 25 It is a diagram for describing output timing of a message.

FIG. 26 It is a diagram illustrating an operation example in a third example.

FIG. 27 It is a diagram illustrating an operation example in a fourth example.

FIG. 28 It is a diagram illustrating an operation example in a fifth example.

FIG. 29 It is a diagram illustrating an operation example in a sixth example.

FIG. 30 It is a diagram illustrating an operation example in a seventh example.

FIG. 31 It is a diagram illustrating an operation example in an eighth example.

### EXAMPLE EMBODIMENT

Example embodiments of the present invention are described below with reference to the drawings. Note that, in all the drawings, a similar constituent element is denoted with a similar reference sign, and description therefor is not included as appropriate. Further, in each of the following drawings, a configuration of a section that does not affect the essence of the present invention is not included, and is not illustrated.

In the example embodiments, “acquisition” includes at least one of retrieval of data or information being stored in another apparatus or a storage medium by an own apparatus (active acquisition), and an input of data or information being output from another apparatus to an own apparatus (passive acquisition). Examples of the active acquisition include sending a request or an inquiry to another apparatus and receiving a response, accessing and reading out another apparatus or a storage medium, and the like. Further, examples of the passive acquisition include receiving information being distributed (transmitted, push-notified, or the like), and the like. Moreover, “acquisition” may refer to selecting and acquiring a piece of data or information being received, or selecting and receiving a piece of data or information being distributed.

### Minimum Configuration Example

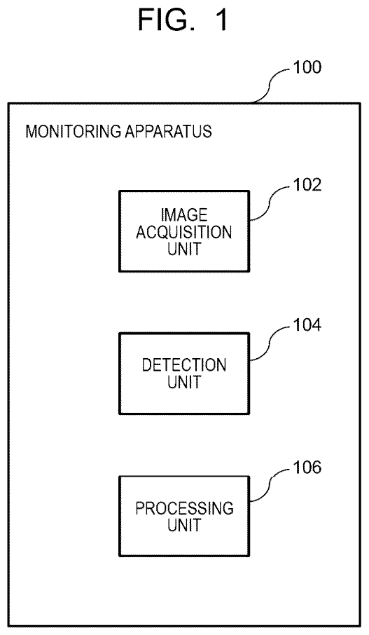

FIG. 1 is a diagram illustrating an overview of a monitoring apparatus 100 according to an example embodiment. The monitoring apparatus 100 includes an image acquisition unit 102, a detection unit 104, and a processing unit 106.

The image acquisition unit 102 acquires an image including a product display region being present within a predetermined range from a settlement apparatus that is operated by a customer and includes functions of product registration and settlement.

The detection unit 104 detects that a customer picks up a product from the product display region by processing the image.

When the detection unit 104 detects that a customer picks up a product, the processing unit 106 executes the following processing (a) and processing (b).

The processing (a), in a case of before completion of accounting processing, is causing an output apparatus to output information for urging registration processing for the product.

The processing (b), in a case of after completion of the accounting processing, is causing a storage apparatus to store customer identifiable information.

### Operation Example

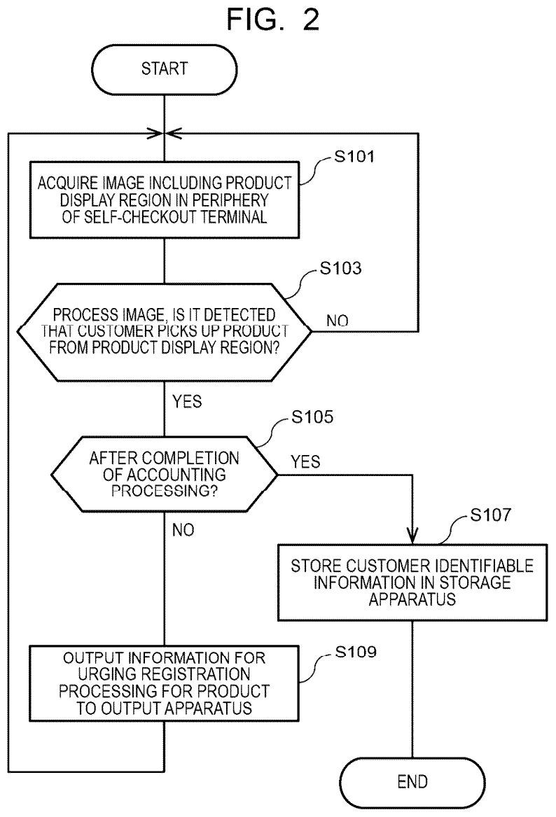

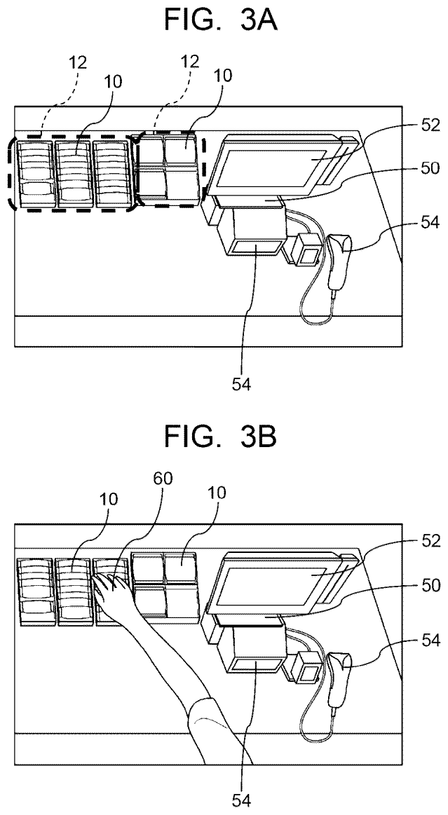

FIG. 2 is a flowchart illustrating an operation example of the monitoring apparatus 100 according to the example embodiment. Further, FIGS. 3A and 3B are diagrams each illustrating an example of an image acquired by capturing a scene in which a customer, who is in the middle of executing product registration processing with a customer-operated settlement apparatus, incidentally buys a product. With reference to FIGS. 2 and 3, description is made below.

First, the image acquisition unit 102 acquires an image including the product display region being present within the predetermined range from the settlement apparatus that is operated by a customer and includes functions of product registration and settlement (step S101). The detection unit 104 detects that a customer picks up a product from the product display region by processing the image (step S103).

As illustrated in FIG. 3A, in a periphery of a customer-operated settlement apparatus (self-checkout terminal 50), a product 10 being a sales promotion target is displayed in a product display region 12 in such a way as to encourage a customer, who is in the middle of executing the product registration processing, to engage in an “incidental buying”. Further, as illustrated in FIG. 3B, the detection unit 104 detects that a hand 60 of a customer enters the product display region in an image by image processing, and thereby detects that the customer possibly picks up a product or the hand 60 of the customer holds a product.

When the detection unit 104 detects that a customer picks up a product (YES in step S103), the processing unit 106 executes the following processing (a) and processing (b).

The processing (a), in the case of before completion of the accounting processing (NO in step S105), is causing the output apparatus to output information for urging the registration processing for the product (step S109).

The processing (b), in the case of after completion of the accounting processing (YES in step S105), is causing the storage apparatus to store the customer identifiable information (step S107).

In the monitoring apparatus 100, the image acquisition unit 102 acquires an image including the product display region being present within the predetermined range from the customer-operated settlement apparatus, and the detection unit 104 detects, by processing the image, that a customer picks up a product from the product display region. Further, when the detection unit 104 detects that a customer picks up a product, the processing unit 106 executes the following processing (a) and processing (b). The processing (a) is processing of causing the output apparatus to output the information for urging the registration processing for the product in a case of before completion of the accounting processing, and the processing (b) is processing of causing the storage apparatus to store the customer identifiable information in a case of after completion of the accounting processing.

According to the monitoring apparatus 100, there can be provided a monitoring system, a monitoring apparatus, a monitoring method, and a storage medium that solve a problem of accounting omission of a product displayed in a periphery of a settlement apparatus that is operated by a customer and includes functions of product registration and settlement.

Detailed examples of the monitoring apparatus 100 are described below.

### Frist Example Embodiment

### System Overview

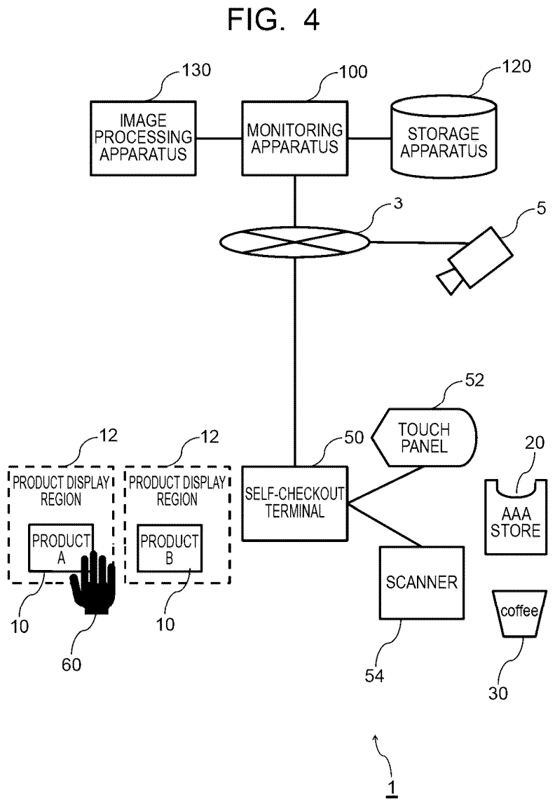

FIG. 4 is a schematic diagram illustrating a system configuration of a monitoring system 1 according to an example embodiment.

The monitoring system 1 includes a monitoring apparatus 100, and at least one camera 5 and at least one self-checkout terminal 50 that are connected to the monitoring apparatus 100 via a communication network 3. The monitoring apparatus 100 includes a storage apparatus 120. The storage apparatus 120 may be provided inside of the monitoring apparatus 100, or may be provided outside thereof. In other words, the storage apparatus 120 may be hardware integrated with the monitoring apparatus 100, or may be hardware separated from the monitoring apparatus 100.

The self-checkout terminal 50 is a settlement apparatus that is operated by a customer and includes functions of product registration and settlement. The self-checkout terminal 50 at least includes a touch panel 52 and a scanner 54. Moreover, the self-checkout terminal 50 may include a printer that prints out a receipt or the like. For example, the touch panel 52 includes a display unit such as a liquid crystal display and an organic electro-luminescence (EL) display, and is acquired by integrating the display unit and an operation unit with each other.

The scanner 54 reads a bar code in which information relating to a product is recorded in order to execute registration processing for the product to be purchased by a customer. The scanner 54 may be a code reader that includes a light source and a photodetector such as a photodiode and detects a product code for identifying a product, or may be a camera that includes a lens and an image sensor element such as a charge coupled device (CCD) image sensor and captures an image including an outer appearance of a product. Further, the scanner 54 may be any of a hand-held type that a customer grips and uses manually, and a stationary type that a product code is brought close to a reading surface and read.

The self-checkout terminal 50 may further include a magnetic card reader or an IC card reader reading a membership card of a store, a credit card, and a cash card (a magnetic card or an IC card) issued by a financial institution, and the like. Alternatively, the self-checkout terminal 50 may include an IC card reader reading a transportation IC card and an IC card from a mobile terminal such as a smartphone by contactless IC communication (near field communication (NFC)). Moreover, the self-checkout terminal 50 may include a reader reading a quick response (QR) code (registered trademark) for QR code payment. At least one of those readers and the scanner 54 may be integrated with each other.

The camera 5 includes a lens and an image sensor element such as a charge coupled device (CCD) image sensor, and is a network camera such as an internet protocol (IP) camera. For example, the network camera includes a wireless local area network (LAN) communication function, and is connected to the monitoring apparatus 100 via the communication network 3, in other words, a relay apparatus (not included in illustration) such as a router. The camera 5 may be a so-called surveillance camera that is installed at each of a plurality of positions in a store or a facility. Further, the camera 5 may include a mechanism that performs control of an orientation of the camera itself or lens to follow movement of a person, control of zooming, a focus setting, and the like.

It is preferred that an image being generated by the camera 5 is captured in real time and transmitted to the monitoring apparatus 100. However, an image being transmitted to the monitoring apparatus 100 may not be transmitted directly from the camera 5, and may be an image being delayed by a predetermined time period. An image being captured by the camera 5 may be stored temporarily in another storage apparatus, and read out by the monitoring apparatus 100 from the another storage apparatus successively or at a predetermined interval. Moreover, an image being transmitted to the monitoring apparatus 100 is preferably a moving image, and may be a frame image at a predetermined interval or a still image.

The monitoring apparatus 100 is further connected to an image processing apparatus 130. However, the image processing apparatus 130 may be provided inside of the monitoring apparatus 100, or may be provided outside thereof. In other words, the image processing apparatus 130 may be hardware integrated with the monitoring apparatus 100, or may be hardware separated from the monitoring apparatus 100.

The image processing apparatus 130 determines positions of a product display region 12, a product 10, and a hand 60 of a customer in an image by subjecting the image being captured by the camera 5 to image recognition processing. Moreover, the image processing apparatus 130 may track movement of at least one of the product 10 and the hand 60 of the customer. Moreover, the image processing apparatus 130 may recognize that the hand 60 of the customer picks up or holds the product 10. Further, a feature value for each product 10 (including a plastic bag, a cup for a self-service beverage, and various items such as chopsticks, a fork, a spoon, and a straw when they are subjected to charge) may be registered in advance, and the image processing apparatus 130 may determine the product 10 in the image by matching processing with the feature value of the product 10.

### Hardware Configuration

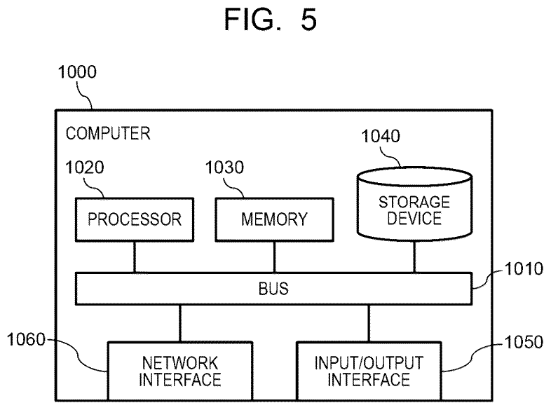

FIG. 5 is a block diagram illustrating a hardware configuration of a computer 1000 that achieves the monitoring apparatus 100. The self-checkout terminal 50 and the image processing apparatus 130 in FIG. 4 are also achieved by the computer 1000. Moreover, the camera 5 in FIG. 4 may be achieved by the computer 1000. Further, functions of the monitoring apparatus 100 may be shared and achieved by at least two of the self-checkout terminal 50, the monitoring apparatus 100, and the camera 5.

The computer 1000 includes a bus 1010, a processor 1020, a memory 1030, a storage device 1040, an input/output interface 1050, and a network interface 1060.

The bus 1010 is a data transmission path in which the processor 1020, the memory 1030, the storage device 1040, the input/output interface 1050, and the network interface 1060 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a memory card, a read only memory (ROM), or the like. The storage device 1040 stores a program module achieving each of the functions (for example, the image acquisition unit 102, the detection unit 104, and the processing unit 106, and a decision unit 108, a determination unit 110, and a registration unit 112 that are described later, and the like) of the monitoring apparatus 100. The processor 1020 reads each of the program modules on the memory 1030 and executes the program module, and thereby each of the functions associated with each of the program modules is achieved. Further, the storage device 1040 may also store each piece of data of the storage apparatus 120 of the monitoring apparatus 100.

The program module may be stored in a storage medium. The storage medium that stores the program module includes a non-transitory and tangible medium that can be used by the computer 1000, and a program code that can be read by the computer 1000 (the processor 1020) may be embedded in the medium.

The input/output interface 1050 is an interface for connecting the computer 1000 and various input/output devices to each other. The input/output interface 1050 also functions as a communication interface that performs short-range wireless communication such as Bluetooth (registered trademark) and near field communication (NFC).

The network interface 1060 is an interface for connecting the computer 1000 to a communication network. For example, the communication network is a local area network (LAN) or a wide area network (WAN). A method of connecting the network interface 1060 to the communication network may be wireless connection, or may be wired connection.

Further, the computer 1000 is connected to a required device (for example, the touch panel 52, the scanner 54, a speaker, a printer, various readers, and the like of the self-checkout terminal 50) via the input/output interface 1050 or the network interface 1060.

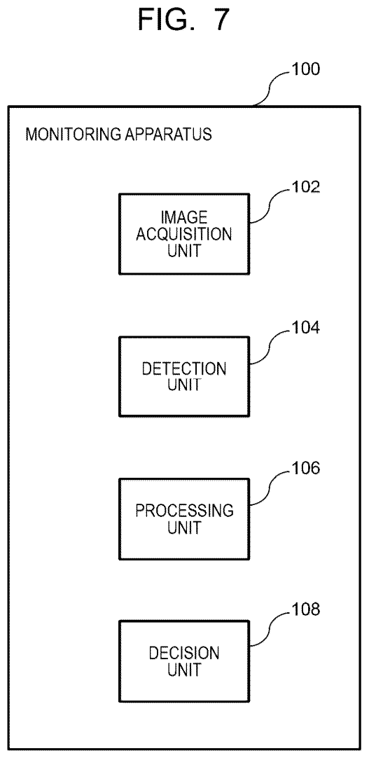

Each of the constituent elements of the monitoring apparatus 100 according to each of the example embodiments in FIG. 1, and FIGS. 7, 12, and 15 that are described later is achieved by any combination of the hardware of the computer 1000 in FIG. 5 and software. Further, it is understood by a person skilled in the art that various modification examples may be made to the achievement method and apparatus. A functional block diagram illustrating the monitoring apparatus 100 according to each of the example embodiments illustrates a block in a logical functional unit instead of a configuration of a hardware unit.

### Functional Configuration Example

A functional configuration example of the monitoring apparatus 100 according to the example embodiment is described with reference to FIG. 1.

The monitoring apparatus 100 includes the image acquisition unit 102, the detection unit 104, and the processing unit 106.

The image acquisition unit 102 acquires an image including the product display region 12 being present within a predetermined range from a settlement apparatus (the self-checkout terminal 50 in FIG. 4) that is operated by a customer and includes functions of product registration and settlement.

For example, the predetermined range is equal to or less than two meters. Alternatively, the predetermined range is a reachable range of the hand 60 of a customer operating the self-checkout terminal 50, a range within an eye sight of a customer, or the like. In other words, it is preferred that the predetermined range is a distance that enables a customer operating the self-checkout terminal 50 to notice and easily hold the product 10. For example, the product 10 is a product being a sales promotion target, and is displayed in the product display region 12 in such a way as to encourage a customer operating the self-checkout terminal 50 to engage in an “incidental buying”.

Further, the product 10 includes a plastic bag 20, and a coffee cup 30 for a self-service coffee machine that are subjected to charge. The product 10 is provided with a bar code for product registration. However, the plastic bag 20 or the coffee cup 30 may not be provided with a bar code for product registration, and a dedicated bar code (or a two-dimensional code) may be provided near the plastic bag 20 or the coffee cup 30, for example. Alternatively, on a product registration screen of the self-checkout terminal 50, use of the plastic bag 20, a type of coffee using the coffee cup 30, or the like may be registered.

The detection unit 104 detects that a customer picks up the product 10 from the product display region 12 by processing an image. The detection unit 104 causes the image processing apparatus 130 to process an image being captured by the camera 5. The image processing apparatus 130 detects that a customer picks up the product 10 from the product display region 12 by executing the image recognition processing. Details of the detection method are described in an example embodiment described later.

When the detection unit 104 detects that a customer picks up the product 10, the processing unit 106 executes the following processing (a) and processing (b).

The processing (a), in the case of before completion of the accounting processing, is causing the output apparatus to output information for urging the registration processing for the product 10.

The processing (b), in the case of after completion of the accounting processing, is causing the storage apparatus 120 to store the information for determining the customer.

The expression “before completion of the accounting processing” indicates a time period from a time point at which a customer stands in front of the self-checkout terminal 50, and pressing of an accounting processing start button on a stand-by screen displayed on the touch panel 52 is received, to a time point at which reception of change and a receipt is completed, the time period including the product registration processing and a settlement procedure. Further, the expression “before completion of the accounting processing” may indicate a time period from a time point at which a customer stands in front of the self-checkout terminal 50 to a time point at which the customer leaves the self-checkout terminal 50.

Examples of a method of deciding whether it is “before completion of the accounting processing” are given below. At least one of the following decision conditions may be used, or a combination of at least two thereof may be used.
(a1) While processing an image from the camera 5 and detecting that a customer stands in front of the self-checkout terminal 50 (for example, the detection unit 104 may execute processing of detecting the customer.) (however, presence of a customer may be detected by, but not limited to, various types of motion sensors such as infrared, visible light, piezoelectric, electrostatic, or ultrasonic sensors.)
(a2) After receiving pressing of the accounting processing start button by a customer on the stand-by screen displayed on the touch panel 52 of the self-checkout terminal 50
(a3) While receiving a product registration operation by a customer with the self-checkout terminal 50
(a4) While receiving a settlement processing operation by a customer with the self-checkout terminal 50
(a5) While detecting a state in which a customer does not receive a receipt or change from the self-checkout terminal 50

The expression “after completion of the accounting processing” indicates a time period from a time point at which reception of change and a receipt by a customer from the self-checkout terminal 50 is completed to a time point of exiting a store. Further, the expression “after completion of the accounting processing” may indicate a time period from a time point at which a customer leaves in front of the self-checkout terminal 50 to a time point of exiting a store.

Examples of a method of deciding whether it is “after completion of the accounting processing” are given below. At least one of the following decision conditions may be used, or a combination of at least two thereof may be used.
(b1) After processing an image from the camera 5 and detecting that a customer, who is in front of the self-checkout terminal 50, leaves
(b2) After detecting that a customer receives a receipt or change from the self-checkout terminal 50
(b3) While processing an image from the camera 5 and being able to track a customer inside a store, or while detecting that the customer is present inside the store
(b4) After processing an image from the camera 5 and detecting that a customer leaves the self-checkout terminal 50, and before detecting that the customer exits a store from an exit gate

For example, the output apparatus includes at least one of the touch panel 52 of the self-checkout terminal 50, a speaker of the self-checkout terminal 50, and a signage display or a speaker being in the periphery of the self-checkout terminal 50, and is not particularly limited as long as a customer can confirm information being output on the spot. When the output apparatus is a display apparatus, a screen indicating information for urging a customer to execute the registration processing for a product is displayed. When the output apparatus is a speaker, a voice sound message indicating information for urging a customer to execute the registration processing for a product is output. Alternatively, information for notifying that a product is unregistered may be printed on a receipt being output from the self-checkout terminal 50. In other words, the output apparatus may be a printer of the self-checkout terminal 50. Moreover, to a terminal such as a smartphone owned by a customer in which an application capable of receiving a receipt issued electronically (hereinafter, referred to as an electronic receipt) is installed in advance, an electronic receipt including information for notifying that there is an unregistered product may be transmitted. In other words, the output apparatus can include a terminal owned by a customer, such as a smartphone and a tablet terminal, in which an application capable of receiving and displaying an electronic receipt is installed.

For example, when a customer picks up a product having a product name “CCC gum”, information to be output is “Scan the product (may be the product name “CCC gum”).”, “Are you forgetting to scan the product (may be the product name “CCC gum”)?”, “There is a product you haven't scanned.”, “CCC gum is a product requiring scanning.”, and the like. In other words, the information to be output includes at least one of a content for urging the registration processing for a product, a content for notifying a customer that the registration processing for a product is not executed, and a content for notifying a customer that the registration processing for a product is required.

Further, the information to be output may include a content, such as “Scan the product you have just picked up.” and “The product you have just picked up requires scanning.”, for spotting a customer picking up a product in real time. With this, a customer recognizes that own behavior is being monitored, and hence it is highly possible to prevent a fraudulent action.

Further, as described above, in a case where an item including a plastic bag, a cup for a self-service beverage (for example, a coffee cup), or various items such as chopsticks, a fork, a spoon, and a straw when they are subjected to charge is picked up by a customer as well, information in which a product is replaced with an item name such as a plastic bag and a coffee cup (or self-service coffee) can also be output. Further, in a case of such items, the information to be output may be an operation screen on the touch panel 52 of the self-checkout terminal 50 for receiving a choice.

For example, when it is detected that a customer picks up a plastic bag or a coffee cup, the processing unit 106 may cause the touch panel 52 of the self-checkout terminal 50 to display an operation screen including information indicating “Input the number of plastic bags you have picked up”, “The plastic bag you have picked up is charged. Select the number you wish to use”, “Select a type of coffee you would like to purchase”, and the like, and a user interface (UI) for receiving an operation of a customer.

Customer identifiable information includes at least one of identification information relating to an electronic settlement medium being used for the accounting processing by the customer, a credit card number, a number of a membership card of a store (identification information relating to a customer), an image including the customer, and a feature value of a person extracted from the image.

For example, as customer identifiable information, information being acquired by the self-checkout terminal 50 can also be used. Alternatively, the customer identifiable information can be acquired by using an image being captured by the camera 5 or extracting a feature value, by processing executed by the image processing apparatus 130.

An image including a customer and an image from which the feature value is extracted may be captured by a camera other than the camera 5, or may be captured by the camera 5.

### Operation Example

An operation example of the monitoring apparatus 100 is described with reference to FIG. 2.

First, the image acquisition unit 102 acquires an image including the product display region 12 being present within the predetermined range from the self-checkout terminal 50 (step S101). For example, the image being acquired by the image acquisition unit 102 is illustrated in FIG. 3A.

Further, the detection unit 104 detects that a customer picks up the product 10 from the product display region 12 by causing the image processing apparatus 130 to process the image being acquired by the image acquisition unit 102 (step S103). The image acquisition processing in step S101 and the detection processing in step S103 may be executed repeatedly while a customer is in front of the self-checkout terminal 50.

As illustrated in FIG. 3A, in the periphery of the customer-operated settlement apparatus (the self-checkout terminal 50), the product 10 being a sales promotion target is displayed in the product display region 12 in such a way as to encourage a customer, who is in the middle of executing the product registration processing, to engage in an “incidental buying”. Further, as illustrated in FIG. 3B, when the hand 60 of the customer enters the product display region 12 and holds the product 10 in the image, the detection unit 104 detects that the customer picks up the product 10.

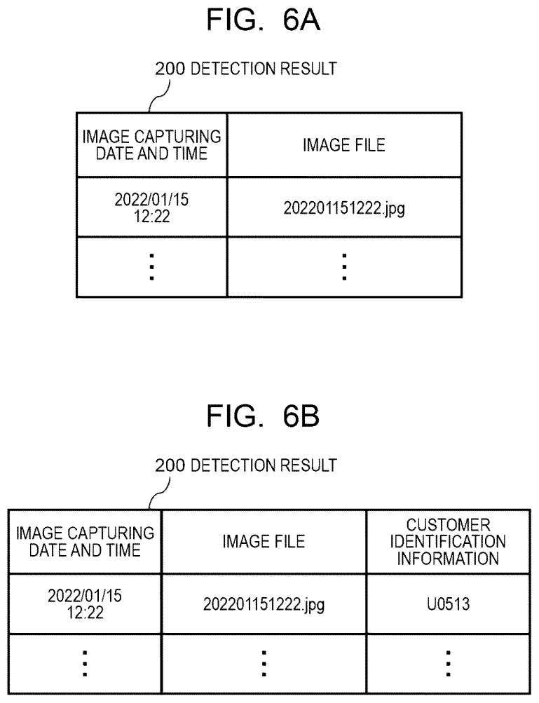

As illustrated in FIG. 6A, a detection result indicating that the product 10 is picked up, which is acquired by the detection unit 104, may be stored in a detection result 200. For example, information indicating at least one of image data from which picking up of a product is detected, identification information relating to an image (for example, a frame number), an image capturing time, identification information relating to the self-checkout terminal 50 operated by a customer, and an image data name is stored in the detection result 200.

When the detection unit 104 detects that a customer picks up a product (YES in step S103), the processing unit 106 executes the following processing (a) and processing (b).

The processing (a), in the case of before completion of the accounting processing (NO in step S105), is causing the output apparatus to output information for urging the registration processing for the product (step S109).

The processing (b), in the case of after completion of the accounting processing (YES in step S105), is causing the storage apparatus 120 to store customer identifiable information (step S107).

In step S109, for example, the processing unit 106 causes information such as “Scan the product.” to be displayed by the touch panel 52 of the self-checkout terminal 50 or to be output as a voice sound from the speaker of the self-checkout terminal 50. Further, the procedure may return to step S101, and monitoring on whether a customer picks up a different product 10 may be continued.

In step S107, for example, as illustrated in FIG. 6B, the processing unit 106 may add the customer identifiable information to the detection result 200, and store the information in the storage apparatus 120. Further, the present processing is terminated. The procedure may return to S101 while preparing for a next customer.

As described above, according to the present example embodiment, the monitoring apparatus 100 includes the image acquisition unit 102, the detection unit 104, and the processing unit 106. The image acquisition unit 102 acquires an image including the product display region 12 being present within the predetermined range from the customer-operated self-checkout terminal 50, and the detection unit 104 detects that a customer picks up the product 10 from the product display region 12 by processing the image. Further, when the detection unit 104 detects that the customer picks up the product 10, the processing unit 106 executes the following processing (a) and processing (b). The processing (a) is processing of causing an output apparatus to output information for urging the registration processing for the product in a case of before completion of the accounting processing, and the processing (b) is processing of causing the storage apparatus 120 to store customer identifiable information in a case of after completion of the accounting processing.

Specifically, when the detection unit 104 detects that a customer picks up the product 10 in the periphery of the self-checkout terminal 50, in a case of before completion of the accounting processing by the self-checkout terminal 50, the processing unit 106 can cause the information for urging the registration processing for the product 10 being picked up to be displayed by the touch panel 52 of the self-checkout terminal 50 or to be output as a voice sound from a speaker of the self-checkout terminal 50. Alternatively, when a customer completes the accounting processing with the self-checkout terminal 5, and leaves even after the detection unit 104 detects that the customer picks up the product 10 in the periphery of the self-checkout terminal 50, the customer identifiable information can be stored in the detection result 200, and hence a store side can manage the customer. In this manner, it is possible to implement a accounting omission.

As described above, according to the monitoring apparatus 100, it is possible to solve a problem of accounting omission of a product displayed in a periphery of a settlement apparatus that is operated by a customer and includes functions of product registration and settlement.

### Second Example Embodiment

FIG. 7 is a functional block diagram illustrating a logical configuration example of a monitoring apparatus 100 according to an example embodiment. The present example embodiment is similar to the above-mentioned example embodiment except for including a configuration of deciding whether a product being picked up by a customer is included in a list of products being read by a self-checkout terminal 50. In addition to the configuration of the monitoring apparatus 100 in FIG. 1, the monitoring apparatus 100 according to the present example embodiment further includes a decision unit 108. Herein, description is made on a configuration acquired by combining the monitoring apparatus 100 according to the present example embodiment with the monitoring apparatus 100 in FIG. 1, and the configuration of the present example embodiment may be acquired by a combination with at least any one of configurations of the other example embodiments without causing contradictions.

### Functional Configuration Example

The decision unit 108 decides whether a product 10 being picked up by a customer is included in a list of products being read by the self-checkout terminal 50 during subsequent product registration processing in a case of before completion of the accounting processing.

When it is decided that the product 10 is not included in the list, a processing unit 106 further causes an output apparatus to output information for urging product registration processing.

The list of products being read by the self-checkout terminal 50 is a list of POS data including at least a product name and a price of a product being read by the self-checkout terminal 50 during the product registration processing. Alternatively, the POS data may include a product code of a product.

The decision unit 108 refers to the list of the POS data, and decides whether the product 10 being detected by a detection unit 104 as being picked up by a customer is included in the list. For example, a decision result may be stored in association with a detection result 200. The decision result includes at least one of information indicating whether the list includes the POS data relating to the product 10, and information indicating legitimacy when the POS data are present and indicating a fraud when the POS data are not present.

Examples of a method of determining the product 10 being picked up by a customer are given below. Further, for example, the information relating to the product 10, which is to be determined herein, is at least one of a product name and a product code of the product 10.
(c1) A feature value of the product 10 is registered in advance, an image processing apparatus 130 subjects an image of the product 10 to the image recognition processing, and the product is determined.
(c2) A product displayed for each product display region 12 is registered in advance. By determining the product display region 12 in an image, a product being associated with the product display region 12 is determined as the product 10 being picked up by a customer, based on a position of a hand 60 of the customer.

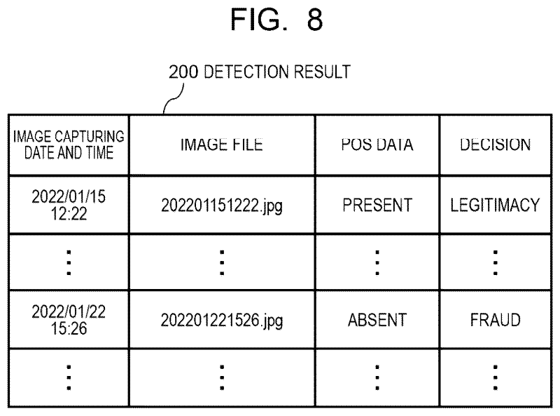

FIG. 8 is a diagram illustrating a data structure example of the detection result 200. In this example, information indicating presence or absence of the POS data and information indicating a fraud or legitimacy is further associated with the detection result 200 in FIGS. 6A and 6B.

The “subsequent product registration processing” is registration processing being executed for a product with the self-checkout terminal 50 after it is detected that a customer picks up the product 10.

Herein, an output apparatus may be similar to that in the first example embodiment. Further, herein, the information for urging the product registration processing may be the same as the information being output after detecting that a customer picks up the product 10, or may be information including a content for urging the registration processing more strongly. In other words, the processing unit 106 outputs information for drawing attention to urge the registration processing for a first time when it is detected that the customer picks up the product 10, and then outputs information for further emphasizing necessity of the registration processing when it is confirmed that scanning of the product 10 is not performed.

For example, when a customer picks up a product having a product name “CCC gum”, information to be output is “There is a product you haven't scanned. Scan the product (may be the product name “CCC gum”).”, “You may forget to scan the product (may be the product name ”CCC gum“). Please scan.”, “CCC gum is charged. Please scan”., and the like.

In other words, the information to be output includes at least one of a content for repeatedly urging the registration processing for a product, a content for notifying a customer that the registration processing for a product is forgotten, and a content for notifying a customer that a product is charged.

Further, in another example, when it is decided that the product 10 is not included in the list, the processing unit 106 causes the output apparatus to output an alert. The processing by the processing unit 106 is also referred to as processing (c). In this example, the output apparatus includes at least one of a touch panel 52 and a speaker of the self-checkout terminal 50, a signage display, a monitoring apparatus of a monitoring center, an administrator terminal, and a clerk terminal. For a customer, the processing unit 106 causes the touch panel 52 of the self-checkout terminal 50 to screen display a warning message (for example, by blinking an icon or displaying in a highlighted manner), or causes the speaker to output a notification sound for drawing attention.

The alert may include information including a message stronger than the information for urging the product registration. For example, the alert preferably includes a content notifying a customer that a picked-up product is charged and requires scanning and a content for instructing the customer to perform scanning, for example, “Scan the product you have picked up.”, “The product you have picked up is charged. Please scan.”, “You forget to scan the product you picked up. Please scan.”, “The product you picked up requires scanning. Please scan.”, and the like.

Further, for an administrator or a clerk of a store, the processing unit 106 outputs, to an apparatus or a terminal belonging to the administrator or the clerk, a warning message including information for notifying that there is a customer who does not register the product 10, and thereby notifies the administrator or the clerk of the store. The processing unit 106 may also transmit including the customer identifiable information to the terminal, or may also transmit including information enabling determination of the self-checkout terminal 50 being used by the customer to the terminal.

With this configuration, the product registration can be urged more strongly for a customer. Further, notification to an administrator or a clerk can be performed, and hence a clerk being present near a customer can urge the product registration by directly calling out.

An operation of the monitoring apparatus 100 according to the example embodiment is described below. Hereinafter, description is made on a first operation example in which the information for urging the product registration is output again and a second operation example 2 in which the output apparatus is caused to output an alert when the POS data are not present.

### First Operation Example

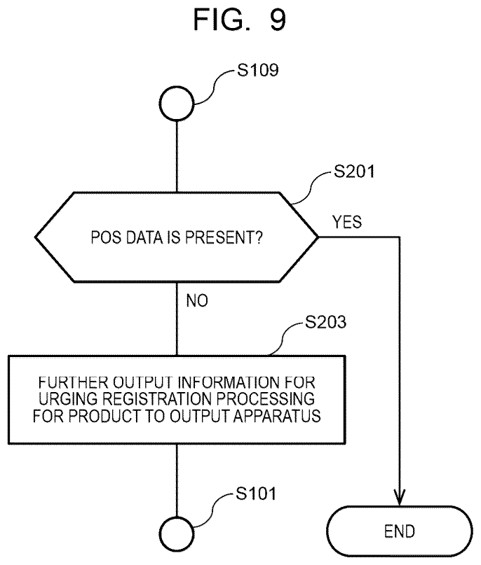

FIG. 9 is a flowchart illustrating an operation example of the monitoring apparatus 100 according to the example embodiment.

The flow is executed after step S109 in FIG. 2. After the processing unit 106 causes the information for urging the product registration to be output in step S109, the decision unit 108 decides whether the product 10 being picked up by a customer is included in the list of products being read by the self-checkout terminal 50 during the subsequent product registration processing (step S201). Specifically, by referring to the list of the POS data of the self-checkout terminal 50, it is decided whether the POS data relating to the product 10 being picked up by the customer are included in the list.

Further, when it is decided that the product 10 is not included in the list (NO in step S201), the processing unit 106 further causes the output apparatus to output the information for urging the product registration processing (step S203). For example, the processing unit 106 causes the touch panel 52 of the self-checkout terminal 50 to display a message such as “You may forget to scan the product (may be the product name “CCC gum”). Please scan.”. Then, the procedure returns to step S101 in FIG. 2.

When it is decided that the product 10 is included in the list (YES in step S201), the processing unit 106 terminates the present processing. Alternatively, the processing may return to step S101 in FIG. 2, and monitoring on whether a different product 10 is picked up may be started.

In this manner, when the list of the POS data does not include the POS data relating to the product 10 after it is detected that a customer picks up the product 10, the information for urging the product registration can be output again.

### Second Operation Example

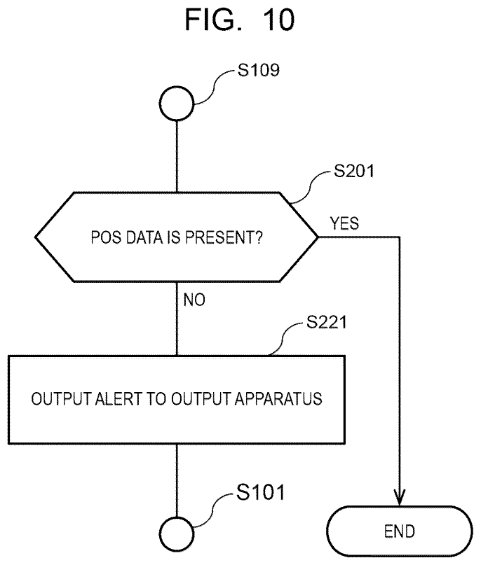

FIG. 10 is a flowchart illustrating an operation example of the monitoring apparatus 100 according to the example embodiment.

The flow is also executed after step S109 in FIG. 2. Step S201 is the same flow as that in FIG. 9. Further, when it is decided that the product 10 is not included in the list (NO in step S201), the processing unit 106 causes the output apparatus to output an alert (step S221). Then, the procedure returns to step S101 in FIG. 2.

Specifically, for a customer, the processing unit 106 causes the touch panel 52 of the self-checkout terminal 50 to screen display a warning message (for example, by blinking an icon or displaying in a highlighted manner), or causes the speaker to output a notification sound for drawing attention. Further, for an administrator or a clerk of a store, the processing unit 106 outputs, to an apparatus or a terminal belonging to the administrator or the clerk, a warning message including information for notifying that there is a customer who does not register the product 10, and thereby notifies the administrator or the clerk of the store.

As described above, in the monitoring apparatus 100 according to the present example embodiment, the decision unit 108 decides whether the product 10 being picked up by a customer is included in the list of products being read by the self-checkout terminal 50 during the subsequent product registration processing in a case of before completion of the accounting processing, and the processing unit 106 further causes the output apparatus to output the information for urging the product registration processing when it is decided that the product 10 is not included in the list.

According to the monitoring apparatus 100, when the product 10 is not included in a list of registered products after it is detected that a customer picks up the product 10 displayed in the periphery of the self-checkout terminal 50, a content for urging the product registration can be displayed on the touch panel 52 of the self-checkout terminal 50. In this manner, the monitoring apparatus 100 according to the present example embodiment achieves an effect similar to that in the above-mentioned example embodiment, and further can acquire an effect of effectively preventing accounting omission of the product 10 of the product display region 12.

Further, in the monitoring apparatus 100 according to the present example embodiment, when it is decided that the product 10 is not included in the list, the processing unit 106 causes the output apparatus to output an alert. According to the monitoring apparatus 100, when the product 10 is not included in the list of the registered products after it is detected that a customer picks up the product 10 displayed in the periphery of the self-checkout terminal 50, the alert can be output to a signage display inside a store, a monitoring apparatus of a monitoring center, an administrator terminal, a clerk terminal, or the like in addition to the self-checkout terminal 50 being used by the customer. As described above, the monitoring apparatus 100 according to the present example embodiment achieves an effect similar to that in the above-mentioned example embodiments, and is further capable of notifying an administrator or a clerk of a store that accounting omission occurs, and hence, for example, an appropriate measure such as directly calling out to the customer by a clerk and urging the product registration is enabled.

### Third Example Embodiment

The present example embodiment is similar to any of the above-mentioned example embodiments except for including a configuration of outputting information for urging registration of a product when it is detected that a customer picks up the product during product registration processing. Description is made while assuming that a monitoring apparatus 100 according to the present example embodiment includes the same configuration as the monitoring apparatus 100 in FIG. 1, and hence description is made below with reference to FIG. 1. However, the configuration of the present example embodiment may be acquired by a combination with at least any one of configurations of the other example embodiments without causing contradictions.

### Functional Configuration Example

A detection unit 104 detects that a customer picks up a product 10 during the product registration processing by processing an image.

When it is detected that a customer picks up the product 10, a processing unit 106 causes an output apparatus to output information for urging registration of the product 10 during the product registration processing.

The processing by the processing unit 106 is similar to the processing (a) in the above-mentioned example embodiment.

For example, in the present example embodiment, a customer is in the middle of performing the product registration operation by using a self-checkout terminal 50, and hence a screen for the product registration processing is displayed on a touch panel 52 of the self-checkout terminal 50. In this state, it is preferred to display information including at least one of a content for urging the registration processing for the product 10 being picked up by a customer, a content for notifying a customer that the registration processing for the product 10 is not executed, and a content for notifying a customer that the registration processing for the product 10 is required.

A criterion for deciding whether it is “during the product registration processing” includes a time period during which the self-checkout terminal 50 receives a product registration operation from a customer. In other words, it includes a time period during which a screen for receiving the product registration is displayed on the operation screen of the self-checkout terminal 50. The expression “during the product registration processing” indicates a time period before receiving pressing of a settlement button on the screen to proceed to settlement processing.

### Operation Example

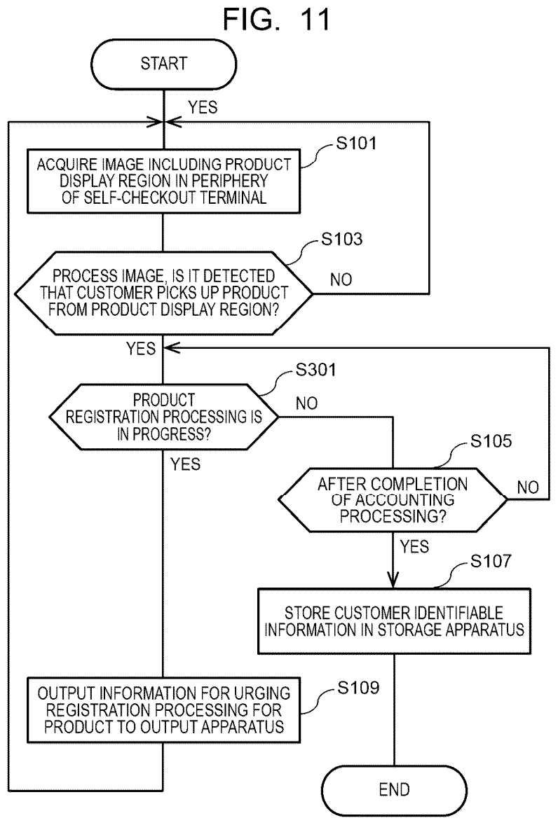

FIG. 11 is a flowchart illustrating an operation example of the monitoring apparatus 100 according to the example embodiment. The flow includes steps similar to those in the flow in FIG. 2, and step S301 is further included between step S103 and step S105 in the flow in FIG. 2.

In this example, when the detection unit 104 detects that a customer picks up the product 10 in step S103 (YES in step S103), the processing unit 106 decides whether the customer is in the middle of executing the product registration processing with the self-checkout terminal 50 (step S301). When it is in the middle of executing the product registration processing (YES in step S301), the procedure proceeds to step S109, and the processing unit 106 causes the output apparatus to output the information for urging the registration processing for the product 10 (step S109). In other words, in a state in which the screen for the product registration processing is displayed on the touch panel 52 of the self-checkout terminal 50, the processing unit 106 causes information including a content for urging the registration processing for the product 10 being picked up by a customer and the like to be displayed on the screen.

On the other hand, when it is not in the middle of the product registration processing (NO in step S301), for example, when it is in the middle of settlement processing or payment processing, the procedure proceeds to step S105. In a case of before completion of accounting processing (NO in step S105), the procedure returns to step S301, which is different from FIG. 2. In other words, stand-by continues until the accounting processing is completed. Further, in a case of after completion of the accounting processing (YES in step S105), the customer identifiable information is stored in the storage apparatus 120 (step S107).

As described above, in the monitoring apparatus 100 according to the present example embodiment, the detection unit 104 detects that a customer picks up the product 10 during the product registration processing by processing an image, and the processing unit 106 causes the output apparatus to output the information for urging registration of the product 10 during the product registration processing when it is detected that the customer picks up the product 10.

According to the monitoring apparatus 100, while a customer is in the middle of executing the product registration processing, a content for urging the product registration for the product 10 being picked up from the product display region 12 by the customer can be displayed on the operation screen of the self-checkout terminal 50 that executes the product registration processing.

In this manner, the monitoring apparatus 100 according to the present example embodiment achieves an effect similar to that in the above-mentioned example embodiments, and further can acquire an effect of effectively preventing accounting omission of the product 10 of the product display region 12.

### Fourth Example Embodiment

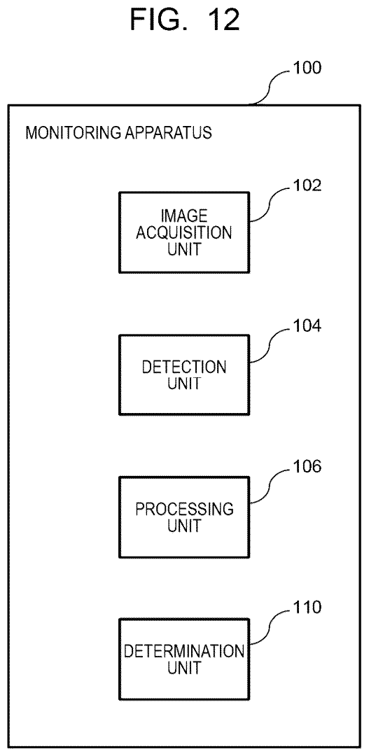

FIG. 12 is a functional block diagram illustrating a logical configuration example of a monitoring apparatus 100 according to an example embodiment. The present example embodiment is similar to any of the above-mentioned example embodiments except for including a configuration of determining, by image processing, whether product registration processing for a product is performed after a customer picks up the product. In addition to the configuration of the monitoring apparatus 100 in FIG. 1, the monitoring apparatus 100 according to the present example embodiment further includes a determination unit 110. Herein, description is made on a configuration acquired by combining the monitoring apparatus 100 according to the present example embodiment with the monitoring apparatus 100 in FIG. 1, and the configuration of the present example embodiment may be acquired by a combination with at least any one of configurations of the other example embodiments without causing contradictions.

### Functional Configuration Example

The determination unit 110 processes an image after a customer picks up a product 10 in a case of before completion of the accounting processing, and thereby determines that product registration processing for the product 10 is executed when a relative distance between a position of a reading apparatus (a scanner 54) for the product registration and a position of at least one of a hand finger of the customer and the product 10 satisfies a criterion.

A processing unit 106 causes an output apparatus to output an alert when a condition is satisfied, the condition where the product registration processing is terminated without determining, by the determination unit 110, that the product registration processing for the product 10 is executed. The processing is similar to the above-mentioned processing (c).

Herein, a method of deciding before completion the accounting processing may be similar to the method described in the above-mentioned example embodiment.

For example “termination of the product registration processing” indicates a time point at which pressing of a settlement button on a product registration screen of a self-checkout terminal 50 is received.

The output apparatus includes at least one of a touch panel 52 of the self-checkout terminal 50, a speaker of the self-checkout terminal 50, a signage display, a monitoring apparatus of a monitoring center, an administrator terminal, and a clerk terminal.

Further, in a case of after completion of the accounting processing, the processing unit 106 may further cause the output apparatus in a store to output the information for urging the registration processing for the product 10. The processing is also referred to as processing (d).

However, in a case of before completion of the accounting processing as well, the processing unit 106 may also execute the processing (d) in place of an output of an alert of the above-mentioned processing (c) or together with an output of an alert of the above-mentioned processing (c). For example, the output apparatus in the store is at least one signage display being installed inside a store at a location different from an installation location of the self-checkout terminal 50, or the like. Alternatively, the output apparatus in the store may include at least one speaker being installed inside the store.

The determination unit 110 causes an image processing apparatus 130 to process an image after it is detected that a customer picks up the product 10. The image processing apparatus 130 determines the relative distance in an image between the position of the scanner 54 of the self-checkout terminal 50 and the position of at least one of a hand finger of a customer and the product 10. The criterion indicates that the relative distance falls within a predetermined range. For example, the predetermined range is a distance in an image being equivalent to several centimeters to 10 centimeters in the actual world.

Preferably, the criterion indicates that the relative distance in an image among the position of the scanner 54 of the self-checkout terminal 50, the position of the hand finger of the customer, and the position of the product 10 falls within the predetermined range. In other words, the criterion indicates that all of the scanner 54 of the self-checkout terminal 50, the hand finger of the customer, and the product 10 are included in the predetermined range.

When the registration processing for the product 10 is executed, a customer brings a bar code of the product 10 close to a reading surface of the scanner 54 and causes to be read. In this state, the product 10 and the scanner 54 are brought close to each other at a constant distance. According to a type of the scanner 54 and a type of the bar code (for example, JAN, CODE39, or the like), a reading distance (a depth of field, DOF) of the scanner 54 differs. Further, the reading distance DOF has a minimum value and a maximum value. Thus, the criterion is preferably that the relative distance falls within a range between at least the minimum value and the maximum value of the reading distance DOF. However, the maximum value of the reading distance DOF is several ten centimeters in some case, and hence it is impossible to determine whether the bar code of the product 10 is read when the maximum value is used as an upper limit of the range. Thus, it is preferred that the maximum value of the reading distance DOF is not used as the upper limit of the predetermined range. As the predetermined range, an average value of a distance by which a customer reads the bar code of the product 10 by using the scanner 54 may be used.

### Method of Setting Criterion

Further, a type of a bar code differs according to a product, and hence the criterion is preferably set according to a type of a bar code provided to the product 10 displayed in a product display region 12. When a plurality of types of the products 10 being provided with different types of bar codes are displayed in the product display region 12, the product display region 12 is divided according to the types of the bar code provided to the products 10. Further, the type of the bar code is registered for each part being divided from the product display region 12. Moreover, the criterion is registered in association with each type of the bar code. The determination unit 110 may determine the type of the bar code of the product 10 being picked up by a customer, which is associated with the product display region 12, and acquire the criterion (a range of the relative distance) associated with the bar code being determined.

In the second example embodiment, whether product registration processing for the product 10 is executed is decided based on whether POS data relating to the product 10 is included in a list of products being subjected to the product registration processing with the self-checkout terminal 50. Meanwhile, in the present example embodiment, the POS data may not be used. Further, there is no need to determine a product name or a product code of the product 10 being picked up by a customer.

When a movement of bringing the product 10 close to the scanner 54 of the self-checkout terminal 50 is detected after it is detected that the customer picks up the product 10 from the product display region 12, in other words, the relative distance between the position of the scanner 54 and the position of the product 10 or a hand finger of a customer is less than a threshold value, it is determined that the product registration processing for the product 10 is executed.

A product identical to the product 10 displayed in the product display region 12 may be displayed in another display shelf in a store. In such a case, the product displayed in the display shelf and the product 10 displayed in the product display region 12 cannot be distinguished from each other by the product code. In other words, even when the POS data relating to the product 10 are in the list of the products, the product does not necessarily correspond to the product 10 displayed in the product display region 12. There may be a case in which the product being picked up from the display shelf is scanned while scanning of the product being picked up from the product display region 12 is forgotten. In such a case, accounting omission of the product being picked up from the product display region 12 cannot be detected.

Meanwhile, according to the configuration of the present example embodiment, because it can be determined that the product registration processing is executed when the product 10 being actually picked up by a customer is brought close to the scanner 54, the product being picked up from the display shelf and the product being picked up from the product display region 12 can be distinguished from each other, and it can be determined whether the product registration processing is executed.

### Operation Example

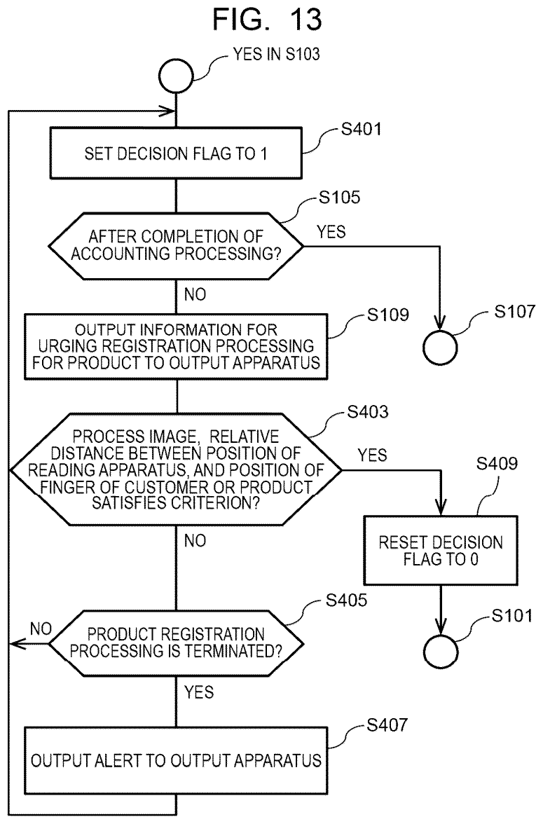

FIG. 13 is a flowchart illustrating an operation example of the monitoring apparatus 100 according to the example embodiment. The flow is started when a detection unit 104 detects that a customer picks up the product 10 in step S103 in FIG. 2.

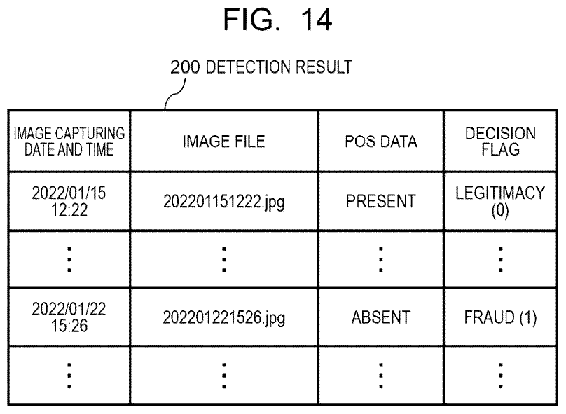

When the detection unit 104 detects that a customer picks up the product 10 (YES in step S103), 1 is set to a decision flag to be used for deciding whether an action of a customer is fraudulent. The decision flag may be stored in the above-mentioned detection result 200. FIG. 14 is a diagram illustrating a data structure example of the detection result 200 that stores the decision flag.

In case of after completion of the accounting processing (YES in step S105), the procedure proceeds to step S107 in FIG. 2, and the processing unit 106 executes the processing (b). In other words, the processing unit 106 causes a storage apparatus 120 to store the customer identifiable information (step S107). On the other hand, in a case of before completion of the accounting processing (NO in step S105), the processing (a) is executed. In other words, the processing unit 106 causes an output apparatus to output information for urging the registration processing for the product (step S109).

After step S109, after a customer picks up the product 10 in a case of before completion of the accounting processing, the determination unit 110 decides whether the relative distance between a position of the scanner 54 and a position of at least one of a hand finger of a customer and the product 10 satisfies the criterion by processing an image (step S403).

When it is decided that the criterion is satisfied (YES in step S403), the determination unit 110 determines that the product registration processing for the product 10 is executed, and resets the decision flag being associated therewith in the detection result 200 to 0 (step S409). Further, the procedure returns to step S101 in FIG. 2.

On the other hand, when it is decided that the criterion is not satisfied (NO in step S403), the processing unit 106 decides whether the product registration processing is completed (step S405). When it is decided that the product registration processing is completed (YES in step S405), the processing unit 106 executes the processing (c) (step S407). In other words, the processing unit 106 causes the output apparatus to output an alert.

However, in step S407, the above-mentioned processing (d) may be executed. The processing unit 106 is capable of executing at least one of the processing (c) and the processing (d).

On the other hand, when it is not decided that the product registration processing is completed (NO in step S405), the procedure returns to step S105. In other words, during the product registration processing, the processing from step S105 to step S403 is repeated, and whether the registration processing for the product 10 is executed is monitored.

Further, when the decision flag is 0, the processing unit 106 does not execute the processing (b) in step S107, the processing (a) in step S109, and the processing (c) in step S407. In the configuration using the decision flag, the processing from step S101 to step S103, the processing from step S105 to step S109, the processing from step S403 to step S409, and the processing from step S405 to step S407 may be executed independently from one another.

While the detection unit 104 continuously executes processing of detecting whether a customer picks up the product 10 throughout the processing from step S101 to step S103, the decision flag is set in step S401, and then the processing unit 106 executes each piece of processing. In this state, after the decision in step S105 and step S405, the processing unit 106 decides whether to execute the processing (b) in step S107, the processing (a) in step S109, and the processing (c) in step S407 by referring to the decision flag. In other words, when 1 is set to the decision flag, each piece of processing is executed due to a fraud being suspected. When 0 is set to the decision flag, each piece of processing is not executed.

As described above, in the monitoring apparatus 100 according to the present example embodiment, after a customer picks up the product 10 in a case of before completion of the accounting processing, the determination unit 110 determines that the product registration processing for the product 10 is executed when the relative distance between a position of the reading apparatus (the scanner 54) for the product registration and a position of at least one of a hand finger of a customer and the product 10 satisfies the criterion by processing an image, and the processing unit 106 causes the output apparatus to output an alert when a condition is satisfied, the condition where the product registration processing is terminated without determining, by the determination unit 110, that the product registration processing for the product 10 is executed. Further, in a case of after completion of the accounting processing, the processing unit 106 further causes the output apparatus in a store to output the information for urging the registration processing for the product 10.

According to the monitoring apparatus 100, determination on whether the product registration for the product 10 being picked up by a customer is executed does not require determination of a product code or a product name of the product 10 being picked up by the customer, and the POS data relating to a registered product may not be used. In the monitoring apparatus 100, it can be determined that the product registration processing is executed when the product 10 being actually picked up by a customer is brought close to the scanner 54. Further, in a case in which the product registration processing for the product 10 is not executed, when the product registration processing is terminated in a case of before completion of the accounting processing, it is possible to output an alert for making a customer aware that the product registration for the product 10 is not executed.

As described above, the monitoring apparatus 100 according to the present example embodiment achieves an effect similar to that in the above-mentioned example embodiments, and accounting omission of the product 10 being picked up from the product display region 12 by a customer can be prevented efficiently because a product being picked up from a display shelf by the customer and a product being picked up from the product display region 12 can be distinguished from each other and whether the product registration processing is executed can be determined.

Further, in a case of before completion of the accounting processing, when the product registration processing is terminated, a customer who is in front of the self-checkout terminal 50 can be notified, by outputting an alert, that the product registration for the product 10 is not executed, and also in a case of after completion of the accounting processing, when the customer leaves the self-checkout terminal 50, a message for urging the product registration for the product 140 can be displayed on a signage display in a store or the like, and hence the customer can be made aware of accounting omission before leaving the store.

### Fifth Example Embodiment

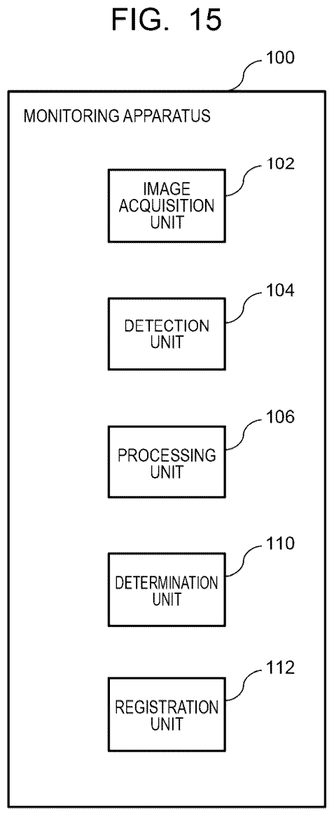

FIG. 15 is a functional block diagram illustrating a logical configuration example of a monitoring apparatus 100 according to an example embodiment. The present example embodiment is similar to any of the above-mentioned example embodiments except for including a configuration of determining, by image processing, and registering a position in an image of a scanner to be used for product registration processing, a product, or the like. In addition to the configuration of the monitoring apparatus 100 in FIG. 12, the monitoring apparatus 100 according to the present example embodiment further includes a registration unit 112. Herein, description is made on a configuration acquired by combining the monitoring apparatus 100 according to the present example embodiment with the monitoring apparatus 100 in FIG. 12, and the configuration of the present example embodiment may be acquired by a combination with at least any one of configurations of the other example embodiments without causing contradictions.

### Functional Configuration Example

By processing an image, the registration unit 112 determines and registers in advance a position in the image of at least one of a scanner 54, a product display region 12, and a product 10.

A detection unit 104 detects, by the image processing, that the product 10 is picked up by detecting that a hand 60 of a customer enters the product display region 12 being registered in advance and then detecting that the product 10 is in the hand 60 of the customer.

Further, the determination unit 110 determines that the product 10 is scanned by detecting that the hand 60 of the customer and the product 10 are present at a position of the scanner 54 being registered in advance, by the image processing.

### Operation Example

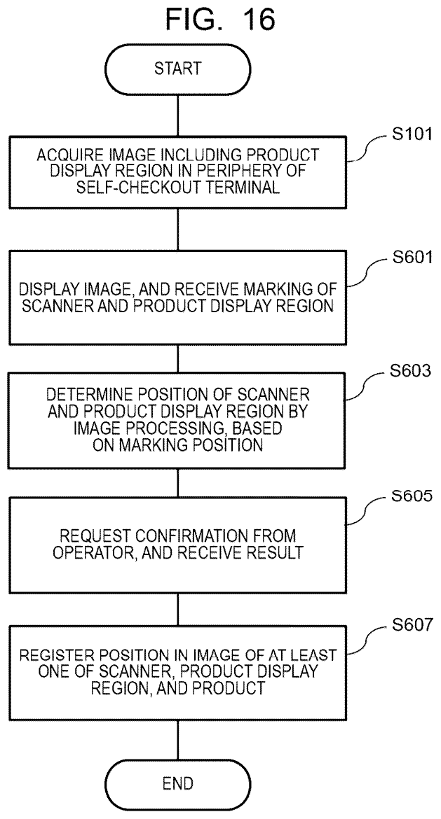

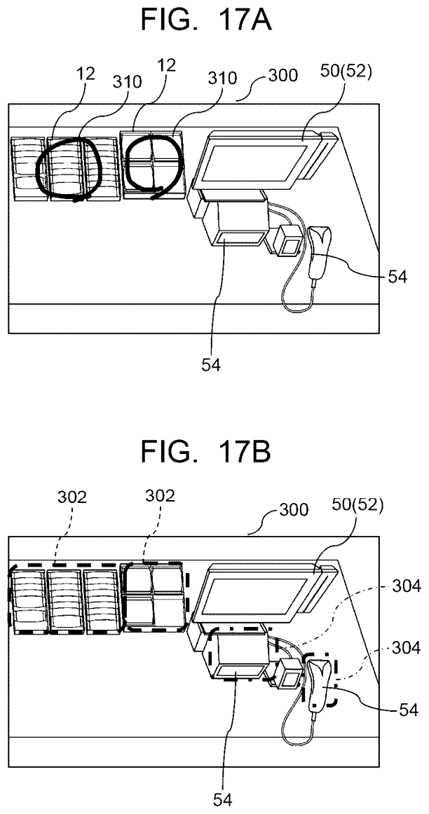

FIG. 16 is a flowchart illustrating an operation example of the monitoring apparatus 100 according to the example embodiment. FIGS. 17A and 17B are diagrams for describing a registration method performed by the registration unit 112. With reference to FIGS. 16 and 17, description is made below.

First, an image acquisition unit 102 acquires an image including the product display region 12 in the periphery of a self-checkout terminal 50 (step S101). Further, the registration unit 112 causes a display apparatus of the monitoring apparatus 100 to display an image 300 being acquired in step S101, causes an operator to mark a position of the product being a monitoring target in the product display region 12 and a position of the scanner 54, and receives a marking operation (step S601). FIG. 17A illustrates a scene in which marking is performed in the product display region 12.

An image processing apparatus 130 is caused to execute the image processing, based on a position of a marking 310 being received, and the registration unit 112 determines a position 302 of the product display region and a position 304 for scanning (step S603). Further, the registration unit 112 may determine a position of each of the products 10 individually by the image processing executed by the image processing apparatus 130. As illustrated in FIGS. 17B, frames indicating the position 302 of the product display region and the position 304 for scanning that are determined are indicated with different line styles from each other. For example, the line style can vary in color, thickness, or type (such as a solid line, a dashed line, or a dotted line), and the frame may be shaded and the shade may vary in pattern or color. The frames indicating the position 302 of the product display region and the position 304 for scanning that are determined are displayed in the image 300 in an overlapping manner.

A result being determined is displayed on a screen, and confirmation from an operator is requested (step S605). When a change is needed, an operation of moving the position 302 or the position 304 or changing a size is received by the operator, and the registration unit 112 changes the position 302 or the position 304 by following a content being received. Herein, each of the position 302 and the position 304 is a range indicated with coordinates, for example.

Alternatively, marking performed by an operator in step S601 may be not included, and the positions of the product display region 12, the scanner 54, and the product 10 may be determined by the image recognition processing executed by the image processing apparatus 130 in step S603.

Further, the registration unit 112 registers a position in the image 300 of at least one of the scanner 54, the product display region 12, and the product 10 as position information 210 in a storage apparatus 120 (step S607).

However, in a case in which the scanner 54 is a handy scanner, even when a position thereof is registered in advance, a place moves, and hence it is preferred that a position of the scanner is determined by the image recognition processing. Thus, in a case of the handy scanner, whether registration processing for the product 10 is executed is determined based on whether a relative distance between a position of the scanner 54, and a position of at least one of a hand finger of the customer and the product 10 satisfies a criterion according to the configuration of the above-mentioned fourth example embodiment. Therefore, position registration of the handy scanner according to the present example embodiment may not be performed in advance.

However, in a case in which there is a fixed place at which the handy scanner is placed, the processing of determining the relative distance between the position of the scanner 54, and the position of at least one of a hand finger of a customer and the product 10 can be started after detecting whether the customer puts the hand 60 on the handy scanner, and hence the placement position of the handy scanner may be registered.

With regard to the position registration processing in the present example embodiment, a clerk or the like updates a content when a position of the product 10 or a position of the scanner 54 is changed.

Further, movement of a position of at least one of the product 10 and the scanner 54 may be detected by causing the image processing apparatus 130 to process an image by using an image captured by a camera 5. When movement is detected, a registered content relating to the position may be updated. A method of detecting movement of a position by the image processing is not particularly limited, and detection may be performed by detecting a difference from a background image, for example.

Further, a position in an image of the product display region 12 may be determined in advance. As described above, a position can be determined by marking performed by an operator, or a position can be determined in advance by the image processing.

The detection unit 104 detects that a customer picks up the product 10 from the product display region 12 by processing an image at the position.

When a position in an image of the product display region 12 is determined in advance as described above, it is only required to process an image including the position, and hence image recognition accuracy can be improved by, for example, executing the image recognition processing suitable for the image of the product display region 12 while enabling to reduce a load of the image processing.

As described above, in the monitoring apparatus 100 according to the present example embodiment, the registration unit 112 processes an image, and thereby determines and registers in advance a position in the image of at least one of the scanner 54, the product display region 12, and the product 10.

As described above, the monitoring apparatus 100 according to the present example embodiment achieves an effect similar to that in the above-mentioned example embodiments, further a region being a target of image recognition can be limited by registering positions of the product 10 and the scanner 54 being detection targets in advance, and thereby enables improvement of recognition accuracy while enabling to reduce a load of the image processing.

### Sixth Example Embodiment

In the present example embodiment, description is made on a minimum configuration example including a configuration of outputting information for urging registration of a product when it is detected that a customer picks up the product during product registration processing. However, the configuration of the present example embodiment may be acquired by a combination with at least any one of configurations of the other example embodiments without causing contradictions.

### Functional Configuration Example

With reference to FIG. 1, description is made below.

A monitoring apparatus 100 includes an image acquisition unit 102, a detection unit 104, and a processing unit 106.

The image acquisition unit 102 acquires an image including a product display region 12 being present within a predetermined range from a settlement apparatus (a self-checkout terminal 50) that is operated by a customer and includes functions of product registration and settlement.

The detection unit 104 detects that a customer picks up a product 10 from the product display region 12 by processing the image.

When the detection unit 104 detects that a customer picks up the product 10, the processing unit 106 causes an output apparatus to output information for urging registration of the product 10 during the product registration processing.

The image acquisition unit 102 and the detection unit 104 are similar to those in the monitoring apparatus 100 according to the above-mentioned example embodiment.

### Operation Example

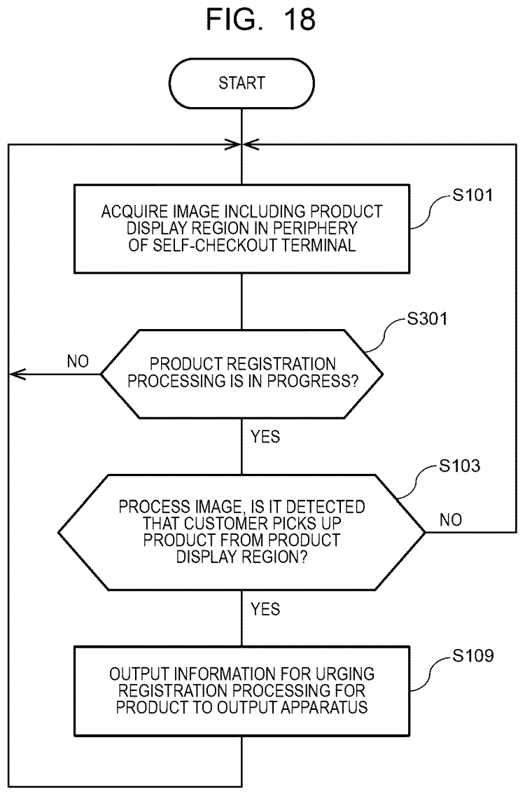

FIG. 18 is a flowchart illustrating an operation example of the monitoring apparatus 100 according to the present example embodiment.

First, the image acquisition unit 102 acquires an image including the product display region 12 being present within the predetermined range from the self-checkout terminal 50 (step S101). Further, the detection unit 104 decides whether the product registration processing is in progress (step S301). Herein, while an operation screen for executing the product registration processing is displayed by the self-checkout terminal 50, it can be decided that the product registration processing is in progress.

Further, in a case of during the product registration processing (YES in step S301), the detection unit 104 detects that a customer picks up the product 10 from the product display region 12 by causing an image processing apparatus 130 to process the image being acquired by the image acquisition unit 102 (step S103). When the detection unit 104 detects that the customer picks up the product 10 (YES in step S103), the processing unit 106 causes the output apparatus to output the information for urging registration of the product 10 during the product registration processing (step S109).

On the other hand, when it is not in the middle of the product registration processing (NO in step S301), for example, when it is in the middle of settlement processing or payment processing before entering the product registration processing, the procedure returns to step S101. Further, when the detection unit 104 does not detect that the customer picks up the product 10 (NO in step S103), the procedure returns to step S101.

According to the monitoring apparatus 100, the image acquisition unit 102 acquires an image including the product display region 12 being present within the predetermined range from the self-checkout terminal 50, the detection unit 104 detects that a customer picks up the product 10 from the product display region 12 by processing the image, and the processing unit 106 causes the output apparatus to output the information for urging registration of the product 10 during the product registration processing when the detection unit 104 detects that the customer picks up the product 10.

Specifically, in a case in which a customer is in the middle of executing the product registration processing with the self-checkout terminal 50, when the detection unit 104 detects that the customer picks up the product 10 in the periphery of the self-checkout terminal 50, the processing unit 106 can cause the information for urging the registration processing for the product 10 being picked up to be displayed by a touch panel 52 of the self-checkout terminal 50 being in the product registration processing or to be output as a voice sound from a speaker of the self-checkout terminal 50.

As described above, according to the monitoring apparatus 100, it is possible to solve a problem of accounting omission of a product displayed in a periphery of a settlement apparatus that is operated by a customer and includes functions of product registration and settlement.

### Seventh Example Embodiment

In the present example embodiment, description is made on a minimum configuration example including a configuration of determining, by image processing, whether product registration processing for a product is executed after it is detected that a customer picks up the product. However, the configuration of the present example embodiment may be acquired by a combination with at least any one of configurations of the other example embodiments without causing contradictions.

### Functional Configuration Example

With reference to FIG. 12, description is made below.

A monitoring apparatus 100 includes an image acquisition unit 102, a detection unit 104, a processing unit 106, and a determination unit 110.

The image acquisition unit 102 acquires an image including a product display region 12 being present within a predetermined range from a settlement apparatus (a self-checkout terminal 50) that is operated by a customer and includes functions of product registration and settlement.

The detection unit 104 detects that a customer picks up a product 10 from the product display region 12 by processing the image.

After a customer picks up the product 10 in a case of before completion of the accounting processing, the determination unit 110 processes an image, and thereby determines that the product registration processing for the product 10 is executed when a relative distance between a position of a reading unit for the product registration, and a position of at least one of a hand finger of the customer and the product 10 satisfies a criterion.

The processing unit 106 causes an output apparatus to output an alert when a condition is satisfied, the condition where the product registration processing is terminated without determining, by the determination unit 110, that the product registration processing for the product 10 is executed (processing (c)).

### Operation Example

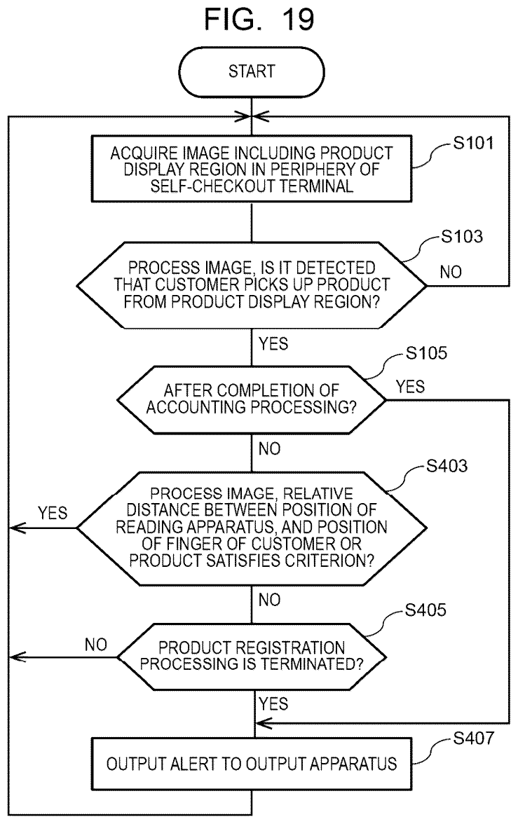

FIG. 19 is a flowchart illustrating an operation example of the monitoring apparatus 100 according to the present example embodiment.

First, the image acquisition unit 102 acquires an image including the product display region 12 being present within the predetermined range from the self-checkout terminal 50 (step S101). Further, the detection unit 104 detects that a customer picks up the product 10 from the product display region 12 by causing an image processing apparatus 130 to process the image being acquired by the image acquisition unit 102 (step S103).

When the detection unit 104 detects that the customer picks up the product 10 (YES in step S103), in a case of before completion of the accounting processing (NO in step S105), after the customer picks up the product 10 the determination unit 110 decides whether the relative distance between the position of the reading unit (a scanner 54) for the product registration, and the position of at least one of a hand finger of the customer and the product 10 satisfies the criterion by causing the image processing apparatus 130 to process the image (step S403).

When it is decided that the criterion is satisfied (YES in step S403), the determination unit 110 determines that the product registration processing for the product 10 is executed, and the procedure returns to step S101. In other words, monitoring on whether a customer picks up a next product 10 from the product display region 12 is continued.

On the other hand, when it is decided that the criterion is not satisfied (NO in step S403), the processing unit 106 decides whether the product registration processing is completed (step S405). When it is decided that the product registration processing is completed (YES in step S405), the processing unit 106 executes the above-mentioned processing (c) (step S407). In other words, the processing unit 106 causes the output apparatus to output an alert.

On the other hand, when it is not decided that the product registration processing is completed (NO in step S405), the procedure returns to step S101. In other words, monitoring on whether a customer picks up a next product 10 from the product display region 12 is continued.

According to the monitoring apparatus 100, the image acquisition unit 102 acquires an image including the product display region 12 being present within the predetermined range from the self-checkout terminal 50, the detection unit 104 detects that a customer picks up the product 10 from the product display region 12 by processing the image, the determination unit 110 determines that the product registration processing for the product 10 is executed when the relative distance between the position of the reading unit for the product registration, and the position of at least one of the hand finger of the customer and the product 10 satisfies the criterion, by processing the image, after the customer picks up the product 10 in a case of before completion of the accounting processing, and the processing unit 106 causes the output apparatus to output an alert when a condition is satisfied, the condition where the product registration processing is terminated without determining, by the determination unit 110, that the product registration processing for the product 10 is executed.

According to the monitoring apparatus 100, determination on whether the product registration for the product 10 being picked up by a customer is executed does not require determination of a product code or a product name of the product 10 being picked up by the customer, and POS data relating to a registered product may not be used. In the monitoring apparatus 100, it can be determined that the product registration processing is executed when the product 10 being actually picked up by a customer is brought close to the scanner 54. Further, in a case in which the product registration processing for the product 10 is not executed, when the product registration processing is terminated before completion of the accounting processing, it is possible to output an alert for making a customer aware that the product registration for the product 10 is not executed.

As described above, according to the monitoring apparatus 100, it is possible to solve a problem of accounting omission of a product displayed in a periphery of a settlement apparatus that is operated by a customer and includes functions of product registration and settlement.

As described, while the example embodiments of the present invention are described with reference to the drawings, those are merely examples of the present invention, and various configurations other than those described above may be adopted.

For example, when there is the product 10 being detected by the detection unit 104 as being picked up by a customer, the processing unit 106 may remove a settlement button for proceeding to settlement processing from an operation screen of the self-checkout terminal 50 for executing the product registration processing, or may deactivate the display of the settlement button and may not accept pressing the button, while performing an output for urging the product registration for the product 10.

### EXAMPLES

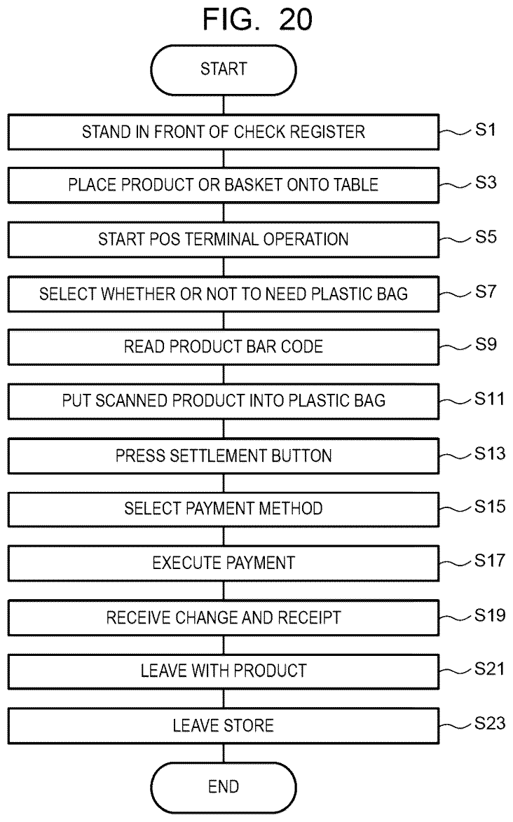

First, with reference to FIG. 20, description is made on an operation example of product registration processing and settlement processing that are executed by a customer with a self-checkout terminal 50. FIG. 20 is a diagram illustrating a procedure example of the product registration processing and the settlement processing with the self-checkout terminal 50.

First, a customer stands in front of the self-checkout terminal 50 (step S1). Further, the customer places a product to be purchased or a shopping basket in which a product is placed onto a table (step S3). Further, the customer starts an operation of the self-checkout terminal 50 (step S5). For example, in this state, a stand-by screen is displayed on a touch panel 52 of the self-checkout terminal 50. When the customer touches the touch panel 52, an initial screen for the product registration processing is displayed.

An operation screen for selecting necessity for a plastic bag is displayed on the initial screen, and hence the customer selects the necessity for a plastic bag (step S7). However, the processing in step S7 may be not included. A product registration processing screen appears when the selection of a plastic bag is terminated, and then the customer reads a bar code of a product with a scanner 54 (step S9). The product whose bar code is read is registered. Further, the customer puts the product being scanned into a plastic bag (or a shopping bag being brought) (step S11).

When scanning of all the products is completed, the settlement button is pressed (step S13). Then, a screen for selecting a payment method appears, and the customer selects a payment method (step S15). Payment is executed by the payment method being selected (step S17). The customer receives change or a receipt (step S19). Further, the customer leaves the place with the product (step S21). Further, the customer leaves a store (step S23).

In this manner, description is made on specific examples associated with the above-mentioned example embodiments, focusing on an output content and output timing for preventing accounting omission of an incidental buying when a customer performs an operation following the procedure in FIG. 20 in front of the self-checkout terminal 50.

### First Example

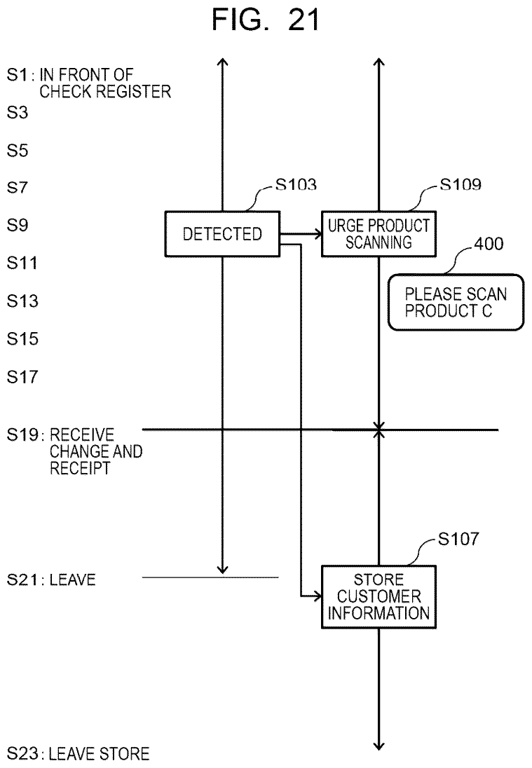

FIG. 21 is a diagram illustrating an operation example in a first example. In the first example, description is made on a case in which a monitoring apparatus 100 performs an operation following the flow in FIG. 2 in the above-mentioned first example embodiment.

While a customer stands in front of the self-checkout terminal 50 (step S1), executes the product registration processing with the self-checkout terminal 50 (step S9), executes the settlement processing (step S13), performs payment (step S17), and receives change and a receipt (step S19), when a detection unit 104 detects that the customer picks up a product 10 from a product display region 12 (YES in step S103), a processing unit 106 causes the touch panel 52 of the self-checkout terminal 50 to display information (a message 400) for urging the customer to execute the product registration for the product 10 (step S109).

Further, after the customer receives change and a receipt (step S19), the processing unit 106 causes a storage apparatus 120 to store the customer identifiable information being detected by the detection unit 104 as a customer who picks up the product 10 (step S107).

As described above, in the first example, accounting omission of the product 10 placed in the periphery of the self-checkout terminal 50 can be prevented effectively. Further, information relating to a customer who leaves without executing the product registration can be managed, and hence it is possible to implement a measure to prevent accounting omission.

### Second Example

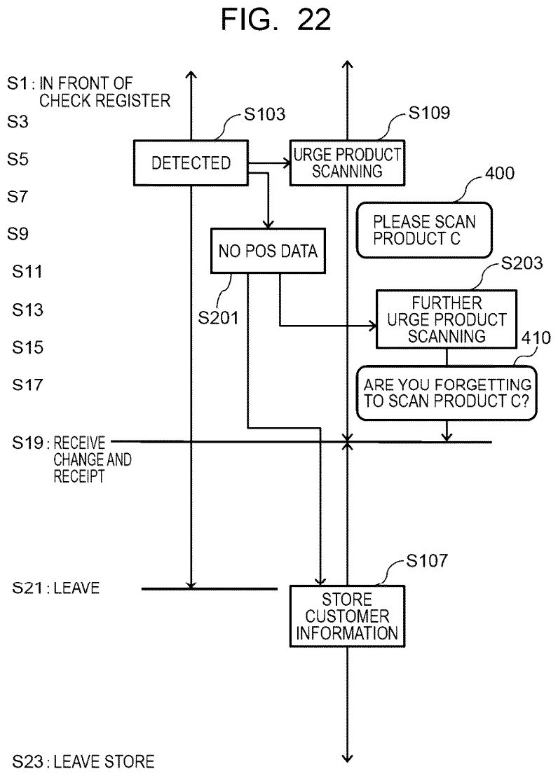

FIG. 22 is a diagram illustrating an operation example in a second example. In the second example, description is made on a case in which the monitoring apparatus 100 performs an operation following the flow of the first operation example in FIG. 9 in the above-mentioned second example embodiment.

While a customer stands in front of the self-checkout terminal 50 (step S1), executes the product registration processing with the self-checkout terminal 50 (step S9), executes the settlement processing (step S13), performs payment (step S17), and receives change and a receipt (step S19), in other words, in a case of before completion of accounting processing, when the detection unit 104 detects that the customer picks up the product 10 from the product display region 12 (YES in step S103), the processing unit 106 causes the touch panel 52 of the self-checkout terminal 50 to display the information (message 400) for urging the customer to execute the product registration for the product 10 (step S109).

On the other hand, after it is detected that the customer picks up the product 10 from the product display region 12 in a case of before completion of the accounting processing, when it is decided that the product 10 is not included in a list (NO in step S201), the processing unit 106 further causes an output apparatus to output the information for urging the product registration processing (a message 410) (step S203).

Further, after the customer receives change and a receipt (step S19), when the detection unit 104 detects picking up of the product 10, and it is decided that the product 10 is not included in the list, the processing unit 106 causes the storage apparatus 120 to store the customer identifiable information (step S107).

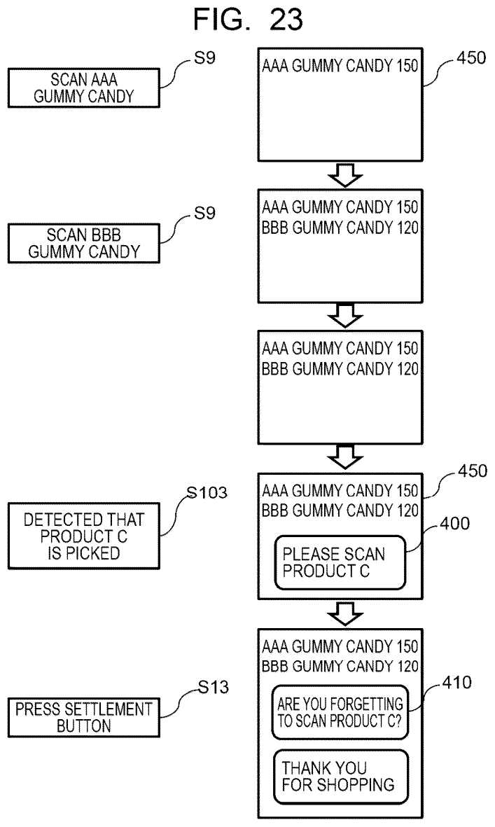

FIGS. 23 to 25 are diagrams for describing output timing of the message 400 and the message 410. In the example in FIG. 23, on the touch panel 52 of the self-checkout terminal 50, a list screen 450 of registered products during the product registration processing is displayed. Further, a customer executes for the product registration for two products (step S9). During the product registration processing, it is detected that the customer picks up the product 10 (product C) from the product display region 12 (step S103). Then, the processing unit 106 causes the message 400 including information for urging the product registration for the product C to be output on the list screen 450 of registered products being displayed on the touch panel 52 of the self-checkout terminal 50.

Further, when the customer presses the settlement button to proceed to the settlement processing (step S13), the product registration processing is to be terminated, and hence the processing unit 106 further causes the message 410 including information for urging the product registration for the product C to be output on the list screen 450 of registered products being displayed on the touch panel 52 of the self-checkout terminal 50 before proceeding to the settlement processing. The message 410 is a content to urge a customer to scan the product 10 more strongly than the message 400.

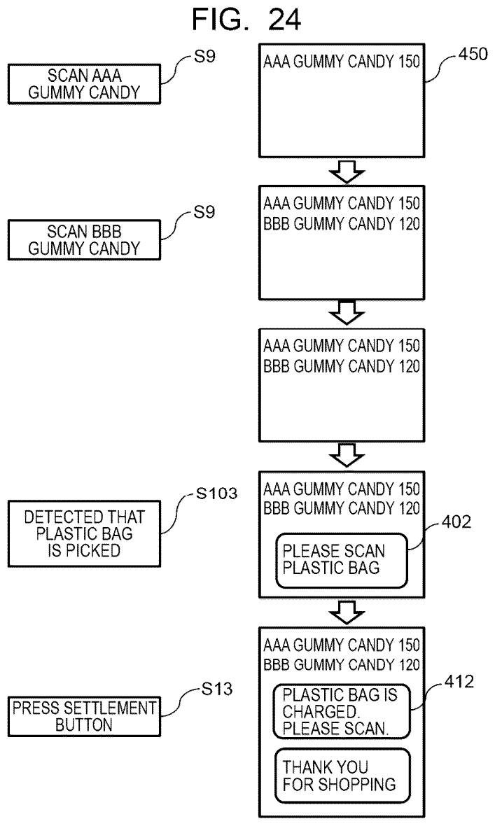

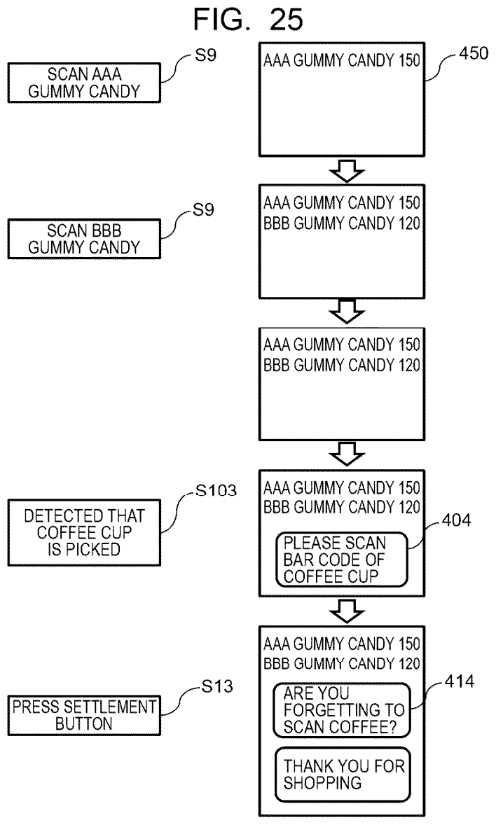

Further, in the example in FIG. 24, examples of a message 402 and a message 412 that are output by the processing unit 106 when the detection unit 104 detects that a customer picks up a plastic bag before completion of the accounting processing are illustrated. In the example in FIG. 25, examples of a message 404 and a message 414 that are output by the processing unit 106 when the detection unit 104 detects that a customer picks up a coffee cup for self-service coffee before completion of the accounting processing are illustrated.

As described above, in the second example, after it is detected that a customer picks up the product 10 from the product display region 12, and then whether the POS data relating to the product 10 is included in a product list of the registered products is confirmed, the information for urging the product registration for the product 10 is output again when the product 10 is not included in the list, and hence accounting omission of the product 10 placed in the periphery of the self-checkout terminal 50 can be prevented further effectively. Further, the information relating to a customer who leaves without executing the product registration can be managed, and hence it is possible to implement a measure to prevent accounting omission.

### Third Example

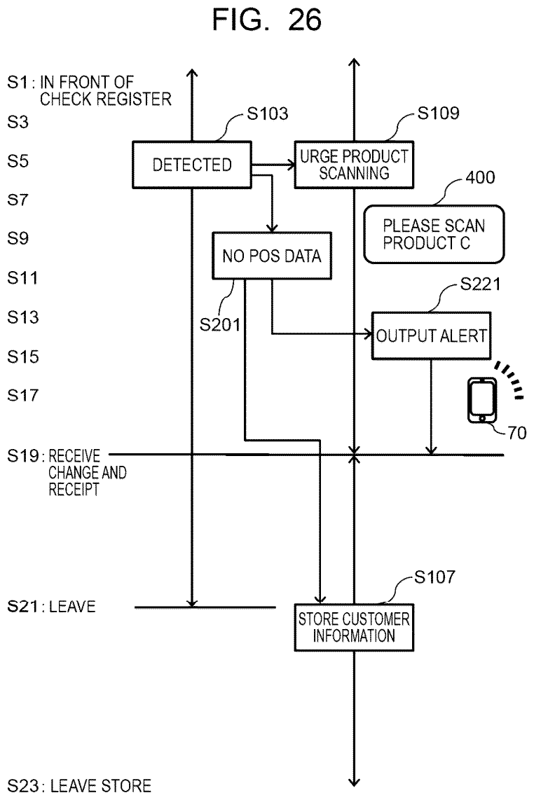

FIG. 26 is a diagram illustrating an operation example in a third example. In the third example, description is made on a case in which the monitoring apparatus 100 performs an operation following the flow of the second operation example in FIG. 10 in the above-mentioned second example embodiment.

While a customer stands in front of the self-checkout terminal 50 (step S1) and receives change and a receipt (step S19), in other words, in a case of before completion of the accounting processing, when the detection unit 104 detects that the customer picks up the product 10 from the product display region 12 (YES in step S103), the processing unit 106 causes the touch panel 52 of the self-checkout terminal 50 to display the information (message 400) for urging the customer to execute the product registration for the product 10 (step S109).

On the other hand, after it is detected that the customer picks up the product 10 from the product display region 12 in a case of before completion of the accounting processing, when it is decided that the product 10 is not included in a list (NO in step S201), the processing unit 106 causes the output apparatus to output an alert (step S221). For example, the processing unit 106 causes a message to be output to a clerk terminal 70, the message for notifying that there is a customer who does not execute the product registration for the product 10 of the product display region 12. Alternatively, the touch panel 52 of the self-checkout terminal 50 may be caused to display the information including a content for strongly urging the product registration for the product 10 being additionally picked up, or a notification sound or a message may be output from a speaker of the self-checkout terminal 50.

Further, after the customer receives change and a receipt (step S19), when the detection unit 104 detects picking up of the product 10, and it is decided that the product 10 is not included in the list, the processing unit 106 causes the storage apparatus 120 to store the customer identifiable information (step S107).

As described above, in the third example, after it is detected that a customer picks up the product 10 from the product display region 12, and then whether the POS data relating to the product 10 is included in a product list of the registered products is confirmed, the output apparatus is caused to output an alert when the product 10 is not included in the list, and hence accounting omission of the product 10 placed in the periphery of the self-checkout terminal 50 can be prevented further effectively. Further, the information relating to a customer who leaves without executing the product registration can be managed, and hence it is possible to implement a measure to prevent accounting omission.

### Fourth Example

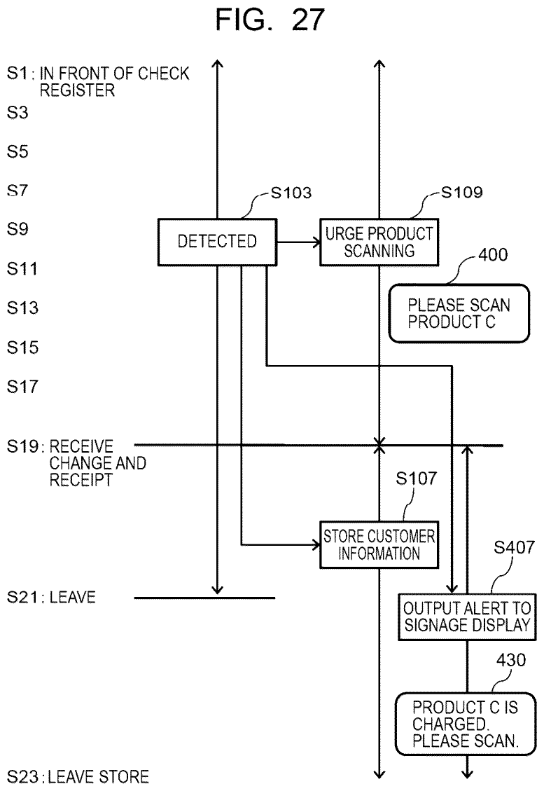

FIG. 27 is a diagram illustrating an operation example in a fourth example. In the fourth example, description is made on a case in which the monitoring apparatus 100 performs an operation following the flow in FIG. 13 in the above-mentioned fourth example embodiment.

While a customer stands in front of the self-checkout terminal 50 (step S1) and receives change and a receipt (step S19), in other words, in a case of before completion of the accounting processing, when the detection unit 104 detects that the customer picks up the product 10 from the product display region 12 (YES in step S103), the processing unit 106 causes the touch panel 52 of the self-checkout terminal 50 to display the information (message 400) for urging the customer to execute the product registration for the product 10 (step S109).

Further, after the customer receives change and a receipt (step S19), when the detection unit 104 detects picking up of the product 10, and it is decided that the product 10 is not included in the list, the processing unit 106 causes the storage apparatus 120 to store the customer identifiable information (step S107). Moreover, the processing unit 106 causes the output apparatus to output an alert (message 430). For example, the touch panel 52 of the self-checkout terminal 50 is caused to display the message 430, and a notification sound and a voice sound are output out of the speaker of the self-checkout terminal 50. The message 430 is a content for warning a customer to perform scanning of the product 10 more strongly than the message 400.

As described above, in the fourth example, after it is detected that a customer picks up the product 10 from the product display region 12, and then the information for urging the product registration for the product 10 is output, when the customer completes the accounting processing and leaves from a front of the self-checkout terminal 50, a signage display in a store or the like can be caused to output an alert instead of the touch panel 52 or the speaker of the self-checkout terminal 50. As described above, a continuous warning for urging the product registration can be issued even after the customer leaves from the front of the self-checkout terminal 50, and hence accounting omission of the product 10 placed in the periphery of the self-checkout terminal 50 can be prevented further effectively. Further, the information relating to a customer who leaves without executing the product registration can be managed, and hence it is possible to implement a measure to prevent accounting omission.

### Fifth Example

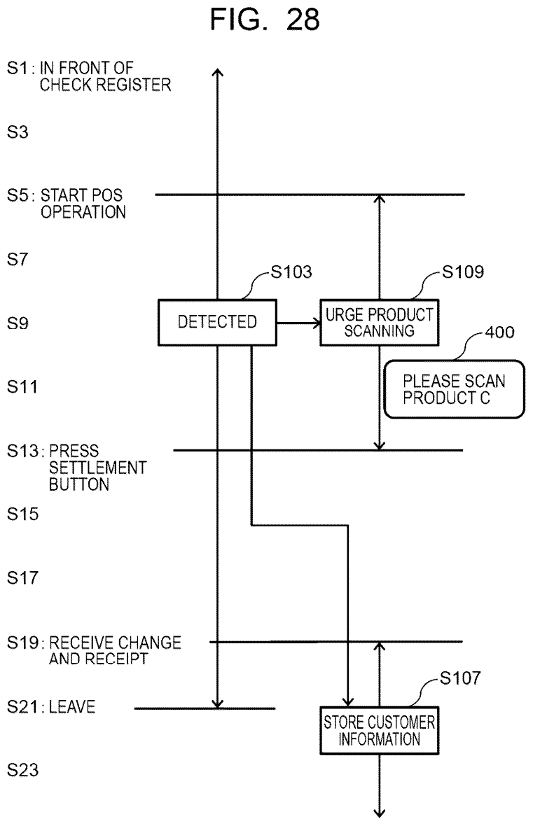

FIG. 28 is a diagram illustrating an operation example in a fifth example. In the fifth example, description is made on a case in which the monitoring apparatus 100 performs an operation following the flow in FIG. 11 in the above-mentioned third example embodiment.

While a customer stands in front of the self-checkout terminal 50 (step S1) and receives change and a receipt (step S19), in other words, in a case of before completion of the accounting processing, the detection unit 104 executes processing of detecting that the customer picks up the product 10 from the product display region 12 (step S103).

Further, during a time period from a time point at which the customer starts the product registration processing (step S5) to a time point at which the settlement button is pressed to proceed to the settlement processing (step S13), in other words, during the product registration processing, when the detection unit 104 detects picking up of the product 10 from the product display region 12 (YES in step S103), the processing unit 106 causes the touch panel 52 of the self-checkout terminal 50 to display the information (message 400) for urging the customer to execute the product registration for the product 10 (step S109).

On the other hand, after the customer receives change and a receipt (step S19), the processing unit 106 causes the storage apparatus 120 to store the customer identifiable information being detected by the detection unit 104 as a customer who picks up the product 10 (step S107).

As described above, in the fifth example, when it is detected that a customer picks up the product 10 from the product display region 12, during the product registration processing, the touch panel 52 of the self-checkout terminal 50 with which the product registration processing is executed can be caused to display the information for urging the customer to execute the product registration for the product 10, and hence accounting omission of the product 10 placed in the periphery of the self-checkout terminal 50 can be prevented further effectively. Further, the information relating to a customer who leaves without executing the product registration can be managed, and hence it is possible to implement a measure to prevent accounting omission.

### Sixth Example

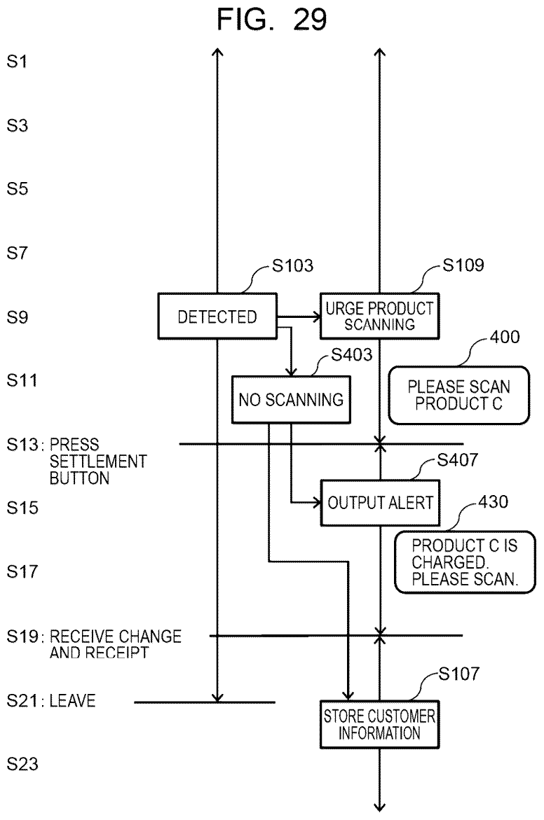

FIG. 29 is a diagram illustrating an operation example in a sixth example. In the sixth example, description is made on a case in which the monitoring apparatus 100 performs an operation following the flow in FIG. 13 in the above-mentioned fourth example embodiment.

While a customer stands in front of the self-checkout terminal 50 (step S1) and receives change and a receipt (step S19), in other words, in a case of before completion of the accounting processing, the detection unit 104 executes the processing of detecting that the customer picks up the product 10 from the product display region 12 (step S103).

Further, when the detection unit 104 detects picking up of the product 10 from the product display region 12 (YES in step S103), the processing unit 106 causes the touch panel 52 of the self-checkout terminal 50 to display the information (message 400) for urging the customer to execute the product registration for the product 10 (step S109) until the product registration processing is terminated, in other words, until the settlement button is pressed to proceed to the settlement processing (step S13).

Further, before the customer receives change and a receipt (step S19), in other words, before completion of the accounting processing, after the customer picks up the product 10, a determination unit 110 decides whether a relative distance between a position of the scanner 54, and a position of at least one of a hand finger of the customer and the product 10 satisfies a criterion by processing an image (step S403).

When it is decided that the criterion is not satisfied (NO in step S403), and the product registration processing is terminated, in other words, after pressing of the settlement button is received (step S13), the processing unit 106 causes the output apparatus to output an alert (step S407). For example, the processing unit 106 causes the touch panel 52 of the self-checkout terminal 50 to display the message 430, and also causes a notification sound and a voice sound to be output out of the speaker of the self-checkout terminal 50. The message 430 is a content for warning a customer to perform scanning of the product 10 more strongly than the message 400.

Further, after the customer receives change and a receipt (step S19), when the detection unit 104 detects picking up of the product 10, and it is decided that the product 10 is not scanned, the processing unit 106 causes the storage apparatus 120 to store the customer identifiable information (step S107).

As described above, in the sixth example, after it is detected that a customer picks up the product 10 from the product display region 12, and then the information for urging the product registration for the product 10 is output, when the product 10 is not scanned by a time of termination of the product registration processing, an alert can be output after termination of the product registration processing. The alert can include one issued for the customer and one issued for a clerk or an administrator. Further, the information relating to a customer who leaves without executing the product registration can be managed, and hence it is possible to implement a measure to prevent accounting omission.

### Seventh Example

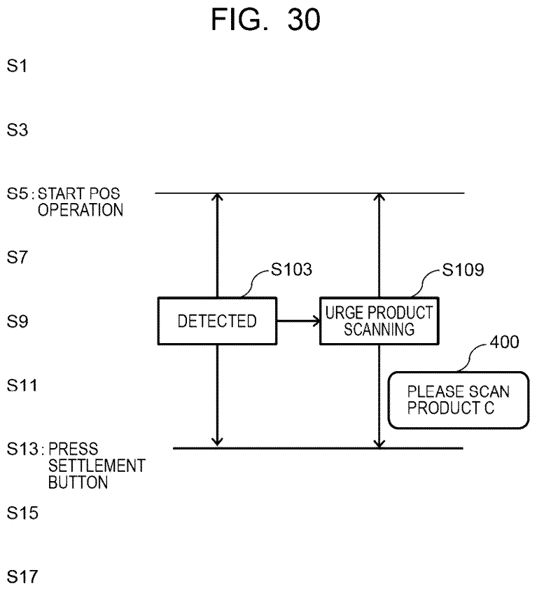

FIG. 30 is a diagram illustrating an operation example in a seventh example. In the seventh example, description is made on a case in which the monitoring apparatus 100 performs an operation following the flow in FIG. 18 in the above-mentioned sixth example embodiment.

During a time period from a time point at which a customer starts the product registration processing (step S5) to a time point at which the settlement button is pressed to proceed to the settlement processing (step S13), in other words, during the product registration processing, the detection unit 104 executes the processing of detecting that the customer picks up the product 10 from the product display region 12 (step S103).

During the product registration processing, when the detection unit 104 detects picking up of the product 10 from the product display region 12 (YES in step S103), the processing unit 106 causes the touch panel 52 of the self-checkout terminal 50 to display the information (message 400) for urging the customer to execute the product registration for the product 10 (step S109).

As described above, in the seventh example, when it is detected that a customer picks up the product 10 from the product display region 12 during the product registration processing, the touch panel 52 of the self-checkout terminal 50 with which the product registration processing is executed can be caused to display the information for urging the customer to execute the product registration for the product 10, and hence accounting omission of the product 10 placed in the periphery of the self-checkout terminal 50 can be prevented further effectively.

### Eighth Example

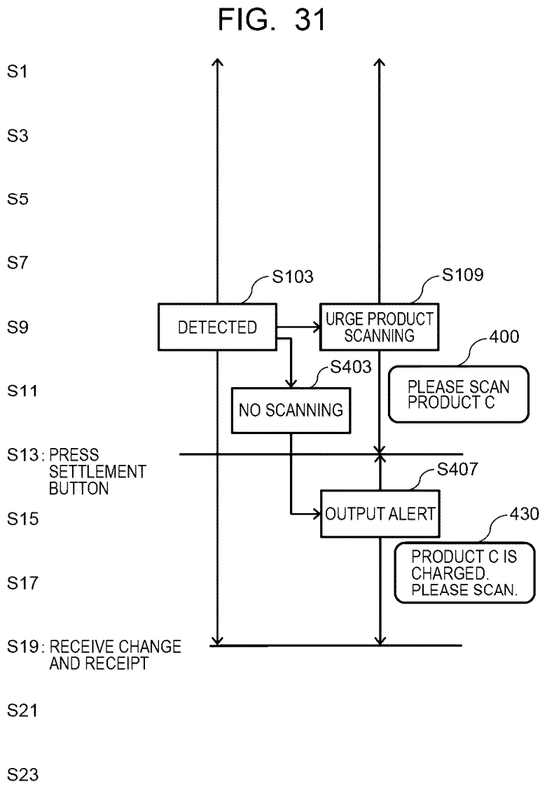

FIG. 31 is a diagram illustrating an operation example in an eighth example. In the eighth example, description is made on a case in which the monitoring apparatus 100 performs an operation following the flow in FIG. 19 in the above-mentioned seventh example embodiment.

While a customer stands in front of the self-checkout terminal 50 (step S1) and receives change and a receipt (step S19), in other words, in a case of before completion of the accounting processing, the detection unit 104 executes the processing of detecting that the customer picks up the product 10 from the product display region 12 (step S103).

When the detection unit 104 detects picking up of the product 10 from the product display region 12 (YES in step S103), the processing unit 106 causes the touch panel 52 of the self-checkout terminal 50 to display the information (message 400) for urging the customer to execute the product registration for the product 10 (step S109).

Further, before the customer receives change and a receipt (step S19), in other words, before completion of the accounting processing, after the customer picks up the product 10, the determination unit 110 decides whether a relative distance between a position of the scanner 54 and a position of at least one of a hand finger of the customer and the product 10 satisfies a criterion by processing an image (step S403).

When it is decided that the criterion is not satisfied (NO in step S403), and the product registration processing is terminated, in other words, after pressing of the settlement button is received (step S13), the processing unit 106 causes the output apparatus to output an alert (step S407). For example, the processing unit 106 causes the touch panel 52 of the self-checkout terminal 50 to display the message 430, and also causes a notification sound and a voice sound to be output out of the speaker of the self-checkout terminal 50. The message 430 is a content for warning a customer to perform scanning of the product 10 more strongly than the message 400.

As described above, in the eighth example, after it is detected that a customer picks up the product 10 from the product display region 12, and then the information for urging the product registration for the product 10 is output, when the product 10 is not scanned by a time of termination of the product registration processing, an alert can be output after termination of the product registration processing. The alert can include one issued for the customer and one issued for a clerk or an administrator.

Further, in a plurality of flowcharts used in the description given above, a plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments described above may be combined with each other within a range where the contents do not conflict with each other.

While the invention of the present application is described above with reference to the example embodiments and the examples, the invention of the present application is not limited to the example embodiments and the examples that are described above. Various modifications that can be understood by a person skilled in the art may be made to the configurations and details of the invention of the present application within the scope of the invention of the present application.

Note that, in the present invention, acquisition and utilization of information relating to a user (customer) is done lawfully.

The whole or a part of the example embodiments described above can be described as, but not limited to, the following supplementary notes.
1. A monitoring apparatus including:
   an image acquisition unit that acquires an image including a product display region being present within a predetermined range from a settlement apparatus being operated by a customer and including a product registration function and a settlement function;
   a detection unit that detects that a customer picks up a product from the product display region by processing the image; and
   a processing unit that, when the detection unit detects that the customer picks up the product,
      causes an output unit to output information for urging registration processing for the product in a case of before completion of accounting processing, and
      causes a storage unit to store customer identifiable information in a case of after completion of accounting processing.
2. The monitoring apparatus according to supplementary note 1, wherein
   the customer identifiable information includes at least one of identification information relating to an electronic settlement medium being used for the accounting processing by the customer, an image including the customer, and a feature value of a person extracted from the image.
3. The monitoring apparatus according to supplementary note 1 or 2, further including
   a decision unit that decides whether the product picked up by the customer is included in a list of products being read by the settlement apparatus during subsequent product registration processing in a case of before completion of the accounting processing, wherein
   the processing unit further causes the output unit to output information for urging product registration processing when it is determined that the product is not included in the list.
4. The monitoring apparatus according to any one of supplementary notes 1 to 3, further including
a decision unit that decides whether the product picked up by the customer is included in a list of products being read by the settlement apparatus during subsequent product registration processing in a case of before completion of the accounting processing, wherein
   the processing unit further causes the output unit to output an alert when it is determined that the product is not included in the list.
5. The monitoring apparatus according to any one of supplementary notes 1 to 4, wherein
   the detection unit detects that the customer picks up a product during product registration processing by processing the image, and,
   when it is detected that the customer picks up the product, the processing unit causes the output unit to output information for urging registration of the product during the product registration processing.
6. The monitoring apparatus according to any one of supplementary notes 1 to 5, further including
   a determination unit that determines that product registration processing is executed for the product, in a case of before completion of the accounting processing, when a relative distance between a position of a reading unit for product registration and a position of at least one of a hand finger of the customer and the product satisfies a criterion, by processing the image after the customer picks up the product, wherein
   the processing unit causes the output unit to output an alert when a condition is satisfied, the condition where the product registration processing is terminated without determining, by the determination unit, that the product registration processing for the product is executed.
7. The monitoring apparatus according to supplementary note 6, wherein
   the processing unit further causes an output unit installed in a store to output information for urging registration processing for the product in a case of after completion of the accounting processing.
8. The monitoring apparatus according to supplementary note 6 or 7, further including
   a registration unit that determines and registers in advance a position of the reading unit in the image by processing the image.
9. The monitoring apparatus according to any one of supplementary notes 6 to 8, further including
   a registration unit that determines and registers in advance a position of at least one of the product display region and the product in the image by processing the image.
10. The monitoring apparatus according to any one of supplementary notes 6 to 9, wherein
   a position of the product display region in the image is set in advance, and
   the detection unit detects that the customer picks up the product from the product display region by processing the image at the position.
11. A monitoring system including:
   a monitoring apparatus;
   a settlement apparatus being operated by a customer and including a product registration function and a settlement function; and
   a camera configured to generate an image including a product display region being present within a predetermined range from the settlement apparatus, wherein
   the monitoring apparatus includes
      an image acquisition unit that acquires the image,
      a detection unit that detects that a customer picks up a product from the product display region by processing the image, and
      a processing unit that, when the detection unit detects that the customer picks up the product,
         causes an output unit to output information for urging registration processing for the product in a case of before completion of accounting processing, and
         causes a storage unit to store customer identifiable information in a case of after completion of accounting processing.
12. The monitoring system according to supplementary note 11, wherein
   the customer identifiable information includes at least one of identification information relating to an electronic settlement medium being used for the accounting processing by the customer, an image including the customer, and a feature value of a person extracted from the image.
13. The monitoring system according to supplementary note 11 or 12, wherein
   the monitoring apparatus further includes
      a decision unit that decides whether the product picked up by the customer is included in a list of products being read by the settlement apparatus during subsequent product registration processing in a case of before completion of the accounting processing, and
   the processing unit of the monitoring apparatus further causes the output unit to output information for urging product registration processing when it is determined that the product is not included in the list.
14. The monitoring system according to any one of supplementary notes 11 to 13, wherein
   the monitoring apparatus further includes
      a decision unit that decides whether the product picked up by the customer is included in a list of products being read by the settlement apparatus during subsequent product registration processing in a case of before completion of the accounting processing, and
   the processing unit of the monitoring apparatus further causes the output unit to output an alert when it is determined that the product is not included in the list.
15. The monitoring system according to any one of supplementary notes 11 to 14, wherein
   the detection unit of the monitoring apparatus detects that the customer picks up a product during product registration processing by processing the image, and,
   when it is detected that the customer picks up the product, the processing unit of the monitoring apparatus causes the output unit to output information for urging registration of the product during the product registration processing.
16. The monitoring system according to any one of supplementary notes 11 to 15, wherein
   the monitoring apparatus further includes
      a determination unit that determines that product registration processing is executed for the product, in a case of before completion of the accounting processing, when a relative distance between a position of a reading unit for product registration and a position of at least one of a hand finger of the customer and the product satisfies a criterion, by processing the image after the customer picks up the product, and
   the processing unit of the monitoring apparatus causes the output unit to output an alert when a condition is satisfied, the condition where the product registration processing is terminated without determining, by the determination unit, that the product registration processing for the product is executed.
17. The monitoring system according to supplementary note 16, wherein
   the processing unit of the monitoring apparatus further causes an output unit installed in a store to output information for urging registration processing for the product in a case of after completion of the accounting processing.
18. The monitoring system according to supplementary note 16 or 17, wherein
   the monitoring apparatus further includes
      a registration unit that determines and registers in advance a position of the reading unit in the image by processing the image.
19. The monitoring system according to any one of supplementary notes 16 to 18, wherein
   the monitoring apparatus further includes
      a registration unit that determines and registers in advance a position of at least one of the product display region and the product in the image by processing the image.
20. The monitoring system according to any one of supplementary notes 16 to 19, wherein
   a position of the product display region in the image is set in advance, and
   the detection unit of the monitoring apparatus detects that the customer picks up the product from the product display region by processing the image at the position.
21. A monitoring method including,
   by one or more computers:
      acquiring an image including a product display region being present within a predetermined range from a settlement apparatus being operated by a customer and including a product registration function and a settlement function;
      detecting that a customer picks up a product from the product display region by processing the image; and,
      when it is detected that the customer picks up the product,
         causing an output unit to output information for urging registration processing for the product in a case of before completion of accounting processing, and
         causing a storage unit to store customer identifiable information in a case of after completion of accounting processing.
22. The monitoring method according to supplementary note 21, wherein
   the customer identifiable information includes at least one of identification information relating to an electronic settlement medium being used for the accounting processing by the customer, an image including the customer, and a feature value of a person extracted from the image.
23. The monitoring method according to supplementary note 21 or 22, further including,
   by the one or more computers:
      deciding whether the product picked up by the customer is included in a list of products being read by the settlement apparatus during subsequent product registration processing in a case of before completion of the accounting processing; and
      further causing the output unit to output information for urging product registration processing when it is determined that the product is not included in the list.
24. The monitoring method according to any one of supplementary notes 21 to 23, further including,
   by the one or more computers:
      deciding whether the product picked up by the customer is included in a list of products being read by the settlement apparatus during subsequent product registration processing in a case of before completion of the accounting processing; and
      further causing the output unit to output an alert when it is determined that the product is not included in the list.
25. The monitoring method according to any one of supplementary notes 21 to 24, further including,
   by the one or more computers
      detecting that the customer picks up a product during product registration processing by processing the image; and,
      when it is detected that the customer picks up the product, causing the output unit to output information for urging registration of the product during the product registration processing.
26. The monitoring method according to any one of supplementary notes 21 to 25, further including,
   by the one or more computers:
      determining that product registration processing is executed for the product, in a case of before completion of the accounting processing, when a relative distance between a position of a reading unit for product registration and a position of at least one of a hand finger of the customer and the product satisfies a criterion, by processing the image after the customer picks up the product; and
      causing the output unit to output an alert when a condition is satisfied, the condition where the product registration processing is terminated without determining, by the determination unit, that the product registration processing for the product is executed.
27. The monitoring method according to supplementary note 26, further including,
   by the one or more computers,
      further causing an output unit installed in a store to output information for urging registration processing for the product in a case of after completion of the accounting processing.
28. The monitoring method according to supplementary note 16 or 17, further including,
   by the one or more computers,
      determining and registering in advance a position of the reading unit in the image by processing the image.
29. The monitoring method according to any one of supplementary notes 26 to 28, further including,
   by the one or more computers,
      determining and registering in advance a position of at least one of the product display region and the product in the image by processing the image.
30. The monitoring method according to any one of supplementary notes 26 to 29, wherein
   a position of the product display region in the image is set in advance,
   the monitoring method further including,
   by the one or more computers,
      detecting that the customer picks up the product from the product display region by processing the image at the position.
31. A computer-readable storage medium configured to store a program for causing a computer to execute:
   a procedure of acquiring an image including a product display region being present within a predetermined range from a settlement apparatus being operated by a customer and including a product registration function and a settlement function;
   a procedure of detecting that a customer picks up a product from the product display region by processing the image; and,
   when it is detected that the customer picks up the product in the procedure of detecting,
      a procedure of causing an output unit to output information for urging registration processing for the product in a case of before completion of accounting processing, and
      a procedure of causing a storage unit to store customer identifiable information in a case of after completion of accounting processing.
32. The computer-readable storage medium configured to store a program according to supplementary note 31, wherein
   the customer identifiable information includes at least one of identification information relating to an electronic settlement medium being used for the accounting processing by the customer, an image including the customer, and a feature value of a person extracted from the image.
33. The computer-readable storage medium configured to store a program according to supplementary note 31 or 32, the program for further causing a computer to execute:
   a procedure of deciding whether the product picked up by the customer is included in a list of products being read by the settlement apparatus during subsequent product registration processing in a case of before completion of the accounting processing; and
   a procedure of further causing the output unit to output information for urging product registration processing when it is determined that the product is not included in the list.
34. The computer-readable storage medium configured to store a program according to any one of supplementary notes 31 to 33, the program for further causing a computer to execute:
   a procedure of deciding whether the product picked up by the customer is included in a list of products being read by the settlement apparatus during subsequent product registration processing in a case of before completion of the accounting processing; and
   a procedure of further causing the output unit to output an alert when it is determined that the product is not included in the list.
35. The computer-readable storage medium configured to store a program according to any one of supplementary notes 31 to 34, the program for further causing a computer to execute:
   a procedure of detecting that the customer picks up a product during product registration processing by processing the image; and
   a procedure of, when it is detected that the customer picks up the product, causing the output unit to output information for urging registration of the product during the product registration processing.
36. The computer-readable storage medium configured to store a program according to any one of supplementary notes 31 to 35, the program for further causing a computer to execute:
   a procedure of determining that product registration processing is executed for the product, in a case of before completion of the accounting processing, when a relative distance between a position of a reading unit for product registration and a position of at least one of a hand finger of the customer and the product satisfies a criterion, by processing the image after the customer picks up the product; and
   a procedure of causing the output unit to output an alert when a condition is satisfied, the condition where the product registration processing is terminated without determining, by the procedure of determining, that the product registration processing for the product is executed.
37. The computer-readable storage medium configured to store a program according to supplementary note 36, the program for further causing a computer to execute
   a procedure of further causing an output unit installed in a store to output information for urging registration processing for the product in a case of after completion of the accounting processing.
38. The computer-readable storage medium configured to store a program according to supplementary note 36 or 37, the program for further causing a computer to execute
   a procedure of determining and registering in advance a position of the reading unit in the image by processing the image.
39. The computer-readable storage medium configured to store a program according to any one of supplementary notes 36 to 38, the program for further causing a computer to execute
   a procedure of determining and registering in advance a position of at least one of the product display region and the product in the image by processing the image.
40. The computer-readable storage medium configured to store a program according to any one of supplementary notes 36 to 39, wherein
   a position of the product display region in the image is set in advance,
   the program for further causing a computer to execute:
   a procedure of detecting that the customer picks up the product from the product display region by processing the image at the position.
41. A program for causing a computer to execute:
   a procedure of acquiring an image including a product display region being present within a predetermined range from a settlement apparatus being operated by a customer and including a product registration function and a settlement function;
   a procedure of detecting that a customer picks up a product from the product display region by processing the image; and,
   when it is detected that the customer picks up the product in the procedure of detecting,
      a procedure of causing an output unit to output information for urging registration processing for the product in a case of before completion of accounting processing, and
      a procedure of causing a storage unit to store customer identifiable information in a case of after completion of accounting processing.
42. The program according to supplementary note 41, wherein
   the customer identifiable information includes at least one of identification information relating to an electronic settlement medium being used for the accounting processing by the customer, an image including the customer, and a feature value of a person extracted from the image.
43. The program according to supplementary note 41 or 42, the program for further causing a computer to execute:
   a procedure of deciding whether the product picked up by the customer is included in a list of products being read by the settlement apparatus during subsequent product registration processing in a case of before completion of the accounting processing; and
   a procedure by the processing unit of further causing the output unit to output information for urging product registration processing when it is determined that the product is not included in the list.
44. The program according to any one of supplementary notes 41 to 43, the program for further causing a computer to execute:
   a procedure of deciding whether the product picked up by the customer is included in a list of products being read by the settlement apparatus during subsequent product registration processing in a case of before completion of the accounting processing; and
   a procedure of further causing the output unit to output an alert when it is determined that the product is not included in the list.
45. The program according to any one of supplementary notes 41 to 44, the program for further causing a computer to execute:
   a procedure of detecting that the customer picks up a product during product registration processing by processing the image; and
   a procedure of, when it is detected that the customer picks up the product, causing the output unit to output information for urging registration of the product during the product registration processing.
46. The program according to any one of supplementary notes 41 to 45, the program for further causing a computer to execute:
   a procedure of determining that product registration processing is executed for the product, in a case of before completion of the accounting processing, when a relative distance between a position of a reading unit for product registration and a position of at least one of a hand finger of the customer and the product satisfies a criterion, by processing the image after the customer picks up the product; and
   a procedure of causing the output unit to output an alert when a condition is satisfied, the condition where the product registration processing is terminated without determining, by the procedure of determining, that the product registration processing for the product is executed.
47. The program according to supplementary note 46, the program for further causing a computer to execute
   a procedure of further causing an output unit installed in a store to output information for urging registration processing for the product in a case of after completion of the accounting processing.
48. The program according to supplementary note 46 or 47, the program for further causing a computer to execute
   a procedure of determining and registering in advance a position of the reading unit in the image by processing the image.
49. The program according to any one of supplementary notes 46 to 48, the program for further causing a computer to execute
   a procedure of determining and registering in advance a position of at least one of the product display region and the product in the image by processing the image.
50. The program according to any one of supplementary notes 46 to 49, wherein
   a position of the product display region in the image is set in advance,
   the program for further causing a computer to execute:
   a procedure of detecting that the customer picks up the product from the product display region by processing the image at the position.
51. A monitoring apparatus including:
   an image acquisition unit that acquires an image including a product display region being present within a predetermined range from a settlement apparatus being operated by a customer and including a product registration function and a settlement function;
   a detection unit that detects that a customer picks up a product from the product display region during product registration processing by processing the image; and
   a processing unit that causes an output unit to output information for urging registration for the product during the product registration processing when the detection unit detects that the customer picks up the product.
52. The monitoring apparatus according to supplementary note 51, wherein
   the customer identifiable information includes at least one of identification information relating to an electronic settlement medium being used for accounting processing by the customer, an image including the customer, and a feature value of a person extracted from the image.
53. The monitoring apparatus according to supplementary note 51 or 52, further including
   a decision unit that decides whether the product picked up by the customer is included in a list of products being read by the settlement apparatus during subsequent product registration processing in a case of before completion of accounting processing, wherein
   the processing unit further causes the output unit to output information for urging product registration processing when it is determined that the product is not included in the list.
54. The monitoring apparatus according to any one of supplementary notes 51 to 53, further including
   a decision unit that decides whether the product picked up by the customer is included in a list of products being read by the settlement apparatus during subsequent product registration processing in a case of before completion of accounting processing, wherein
   the processing unit further causes the output unit to output an alert when it is determined that the product is not included in the list.
55. The monitoring apparatus according to any one of supplementary notes 51 to 54, further including
   a determination unit that determines that product registration processing is executed for the product, in a case of before completion of accounting processing, when a relative distance between a position of a reading unit for product registration and a position of at least one of a hand finger of the customer and the product satisfies a criterion, by processing the image after the customer picks up the product, wherein
   the processing unit causes the output unit to output an alert when a condition is satisfied, the condition where the product registration processing is terminated without determining, by the determination unit, that the product registration processing for the product is executed.
56. The monitoring apparatus according to supplementary note 55, wherein
   the processing unit further causes an output unit installed in a store to output information for urging registration processing for the product in a case of after completion of the accounting processing.
57. The monitoring apparatus according to supplementary note 55 or 56, further including
   a registration unit that determines and registers in advance a position of the reading unit in the image by processing the image.
58. The monitoring apparatus according to any one of supplementary notes 55 to 57, further including
   a registration unit that determines and registers in advance a position of at least one of the product display region and the product in the image by processing the image.
59. The monitoring apparatus according to any one of supplementary notes 55 to 58, wherein
   a position of the product display region in the image is set in advance, and
   the detection unit detects that the customer picks up the product from the product display region by processing the image at the position.
60. A monitoring system including:
   a monitoring apparatus;
   a settlement apparatus being operated by a customer and including a product registration function and a settlement function; and
   a camera configured to generate an image including a product display region being present within a predetermined range from the settlement apparatus, wherein
   the monitoring apparatus includes
      an image acquisition unit that acquires an image including a product display region being present within a predetermined range from a settlement apparatus being operated by a customer and including a product registration function and a settlement function,
      a detection unit that detects that a customer picks up a product from the product display region during product registration processing by processing the image, and
      a processing unit that causes an output unit to output information for urging registration for the product during the product registration processing when the detection unit detects that the customer picks up the product.
61. A monitoring method including,
   by one or more computers:
      acquiring an image including a product display region being present within a predetermined range from a settlement apparatus being operated by a customer and including a product registration function and a settlement function;
      detecting that a customer picks up a product from the product display region during product registration processing by processing the image; and
      causing an output unit to output information for urging registration for the product during the product registration processing when the detection unit detects that the customer picks up the product.
62. A program for causing a computer to execute:
   a procedure of acquiring an image including a product display region being present within a predetermined range from a settlement apparatus being operated by a customer and including a product registration function and a settlement function;
   a procedure of detecting that a customer picks up a product from the product display region during product registration processing by processing the image; and
   a procedure of causing an output unit to output information for urging registration for the product during the product registration processing when the detection unit detects that the customer picks up the product.
63. A computer-readable storage medium configured to store a program for causing a computer to execute:
   a procedure of acquiring an image including a product display region being present within a predetermined range from a settlement apparatus being operated by a customer and including a product registration function and a settlement function;
   a procedure of detecting that a customer picks up a product from the product display region during product registration processing by processing the image; and
   a procedure of causing an output unit to output information for urging registration for the product during the product registration processing when the detection unit detects that the customer picks up the product.
64. A monitoring apparatus including:
   an image acquisition unit that acquires an image including a product display region being present within a predetermined range from a settlement apparatus being operated by a customer and including a product registration function and a settlement function;
   a detection unit that detects that a customer picks up a product from the product display region by processing the image;
   a determination unit that determines that product registration processing is executed for the product when a relative distance between a position of a reading unit for product registration and a position of at least one of a hand finger of the customer and the product satisfies a criterion, by processing the image before completion of accounting processing and after the customer picks up the product; and
   a processing unit that causes an output unit to output an alert when a condition is satisfied, the condition where the product registration processing is terminated without determining, by the determination unit, that the product registration processing for the product is executed.
65. The monitoring apparatus according to supplementary note 64, wherein
   the customer identifiable information includes at least one of identification information relating to an electronic settlement medium being used for accounting processing by the customer, an image including the customer, and a feature value of a person extracted from the image.
66. The monitoring apparatus according to supplementary note 64 or 65, further including
   a decision unit that decides whether the product picked up by the customer is included in a list of products being read by the settlement apparatus during subsequent product registration processing in a case of before completion of accounting processing, wherein
   the processing unit further causes the output unit to output information for urging product registration processing when it is determined that the product is not included in the list.
67. The monitoring apparatus according to any one of supplementary notes 64 to 66, further including
   a decision unit that decides whether the product picked up by the customer is included in a list of products being read by the settlement apparatus during subsequent product registration processing in a case of before completion of accounting processing, wherein
   the processing unit further causes the output unit to output an alert when it is determined that the product is not included in the list.
68. The monitoring apparatus according to any one of supplementary notes 64 to 67, wherein
   the detection unit detects that the customer picks up a product during product registration processing by processing the image, and,
   when it is detected that the customer picks up the product, the processing unit causes the output unit to output information for urging registration of the product during the product registration processing.
69. The monitoring apparatus according to any one of supplementary notes 64 to 68, wherein
   the processing unit further causes an output unit installed in a store to output information for urging registration processing for the product in a case of after completion of accounting processing.
70. The monitoring apparatus according to any one of supplementary notes 64 to 69, further including
   a registration unit that determines and registers in advance a position of the reading unit in the image by processing the image.
71. The monitoring apparatus according to any one of supplementary notes 64 to 70, further including
   a registration unit that determines and registers in advance a position of at least one of the product display region and the product in the image by processing the image.
72. The monitoring apparatus according to any one of supplementary notes 64 to 71, wherein
   a position of the product display region in the image is set in advance, and
   the detection unit detects that the customer picks up the product from the product display region by processing the image at the position.
73. A monitoring system including:
   a monitoring apparatus;
   a settlement apparatus being operated by a customer and including a product registration function and a settlement function; and
   a camera configured to generate an image including a product display region being present within a predetermined range from the settlement apparatus, wherein
   the monitoring apparatus includes
      an image acquisition unit that acquires an image including a product display region being present within a predetermined range from a settlement apparatus being operated by a customer and including a product registration function and a settlement function,
      a detection unit that detects that a customer picks up a product from the product display region by processing the image,
      a determination unit that determines that product registration processing is executed for the product when a relative distance between a position of a reading unit for product registration and a position of at least one of a hand finger of the customer and the product satisfies a criterion, by processing the image before completion of accounting processing and after the customer picks up the product, and
      a processing unit that causes an output unit to output an alert when a condition is satisfied, the condition where the product registration processing is terminated without determining, by the determination unit, that the product registration processing for the product is executed.
74. A monitoring method including,
   by one or more computers:
      acquiring an image including a product display region being present within a predetermined range from a settlement apparatus being operated by a customer and including a product registration function and a settlement function;
      detecting that a customer picks up a product from the product display region by processing the image;
      determining that product registration processing is executed for the product when a relative distance between a position of a reading unit for product registration and a position of at least one of a hand finger of the customer and the product satisfies a criterion, by processing the image before completion of accounting processing and after the customer picks up the product; and
      causing an output unit to output an alert when a condition is satisfied, the condition where the product registration processing is terminated without determining that the product registration processing for the product is executed.
75. A program for causing a computer to execute:
   a procedure of acquiring an image including a product display region being present within a predetermined range from a settlement apparatus being operated by a customer and including a product registration function and a settlement function;
   a procedure of detecting that a customer picks up a product from the product display region by processing the image;
   a procedure of determining that product registration processing is executed for the product when a relative distance between a position of a reading unit for product registration and a position of at least one of a hand finger of the customer and the product satisfies a criterion, by processing the image before completion of accounting processing and after the customer picks up the product; and
   a procedure of causing an output unit to output an alert when a condition is satisfied, the condition where the product registration processing is terminated without determining, by the procedure of determining, that the product registration processing for the product is executed.
76. A computer-readable storage medium configured to store a program for causing a computer to execute:
   a procedure of acquiring an image including a product display region being present within a predetermined range from a settlement apparatus being operated by a customer and including a product registration function and a settlement function;
   a procedure of detecting that a customer picks up a product from the product display region by processing the image;
   a procedure of determining that product registration processing is executed for the product when a relative distance between a position of a reading unit for product registration and a position of at least one of a hand finger of the customer and the product satisfies a criterion, by processing the image before completion of accounting processing and after the customer picks up the product; and
   a procedure of causing an output unit to output an alert when a condition is satisfied, the condition where the product registration processing is terminated without determining, by the procedure of determining, that the product registration processing for the product is executed.

### REFERENCE SIGNS LIST

1 Monitoring system
3 Communication network
5 Camera
10 Product
12 Product display region
20 Plastic bag
30 Coffee cup
50 Self-checkout terminal
52 Touch panel
54 Scanner
60 Hand
70 Clerk terminal
100 Monitoring apparatus
102 Image acquisition unit
104 Detection unit
106 Processing unit
108 Decision unit
110 Determination unit
112 Registration unit
120 Storage apparatus
130 Image processing apparatus
200 Detection result
1000 Computer
1010 Bus
1020 Processor
1030 Memory
1040 Storage device
1050 Input/output interface
1060 Network interface

What is claimed is:

1. A monitoring apparatus comprising:
at least one memory configured to store instructions; and
at least one processor configured to execute the instructions to:
acquire an image including a product display region being present within a predetermined range from a settlement apparatus being operated by a customer and including a product registration function and a settlement function;
detect that a customer picks up a product from the product display region by processing the image; and
a processing unit that, when the detection unit detects that the customer picks up the product,
cause an output unit to output information for urging registration processing for the product in a case of before completion of accounting processing, and
cause a storage unit to store customer identifiable information in a case of after completion of accounting processing.

2. The monitoring apparatus according to claim 1, wherein
the customer identifiable information includes at least one of identification information relating to an electronic settlement medium being used for the accounting processing by the customer, an image including the customer, and a feature value of a person extracted from the image.

3. The monitoring apparatus according to claim 1, wherein
the at least one processor is further configured to execute the instructions to:
decide whether the product picked up by the customer is included in a list of products being read by the settlement apparatus during subsequent product registration processing in a case of before completion of the accounting processing; and
cause the output unit to output information for urging product registration processing when it is determined that the product is not included in the list.

4. The monitoring apparatus according to claim 1, wherein
the at least one processor is further configured to execute the instructions to:
decide whether the product picked up by the customer is included in a list of products being read by the settlement apparatus during subsequent product registration processing in a case of before completion of the accounting processing; and
cause the output unit to output an alert when it is determined that the product is not included in the list

5. The monitoring apparatus according to claim 1, wherein
the at least one processor is further configured to execute the instructions to:
detect that the customer picks up a product during product registration processing by processing the image, and,
when it is detected that the customer picks up the product, cause the output unit to output information for urging registration of the product during the product registration processing.

6. The monitoring apparatus according to comprising claim 1, wherein
the at least one processor is further configured to execute the instructions to:
determine that determines that product registration processing is executed for the product, in a case of before completion of the accounting processing, when a relative distance between a position of a reading unit for product registration and a position of at least one of a hand finger of the customer and the product satisfies a criterion, by processing the image after the customer picks up the product; and
cause the output unit to output an alert when a condition is satisfied, the condition where the product registration processing is terminated without determining, by the determination unit, that the product registration processing for the product is executed.

7. The monitoring apparatus according to claim 6, wherein
the at least one processor is further configured to execute the instructions to
cause an output unit installed in a store to output information for urging registration processing for the product in a case of after completion of the accounting processing.

8. The monitoring apparatus according to claim 6, wherein
the at least one processor is further configured to execute the instructions to
determine and register in advance a position of the reading unit in the image by processing the image.

9. The monitoring apparatus according to claim 6, wherein
the at least one processor is further configured to execute the instructions to
determine and register in advance a position of at least one of the product display region and the product in the image by processing the image.

10. The monitoring apparatus according to claim 6, wherein
a position of the product display region in the image is set in advance, and
the at least one processor is further configured to execute the instructions to
detect that the customer picks up the product from the product display region by processing the image at the position.

11. A monitoring system comprising:
a monitoring apparatus according to claim 1;
a settlement apparatus being operated by a customer and including a product registration function and a settlement function; and
a camera configured to generate an image including a product display region being present within a predetermined range from the settlement apparatus.

12. A monitoring method comprising,
by one or more computers:
acquiring an image including a product display region being present within a predetermined range from a settlement apparatus being operated by a customer and including a product registration function and a settlement function;
detecting that a customer picks up a product from the product display region by processing the image; and,
when it is detected that the customer picks up the product,
causing an output unit to output information for urging registration processing for the product in a case of before completion of accounting processing, and
causing a storage unit to store customer identifiable information in a case of after completion of accounting processing.

13. A non-transitory computer-readable storage medium storing a program for causing a computer to execute:
a procedure of acquiring an image including a product display region being present within a predetermined range from a settlement apparatus being operated by a customer and including a product registration function and a settlement function;
a procedure of detecting that a customer picks up a product from the product display region by processing the image; and,
when it is detected that the customer picks up the product in the procedure of detecting,
a procedure of causing an output unit to output information for urging registration processing for the product in a case of before completion of accounting processing, and
a procedure of causing a storage unit to store customer identifiable information in a case of after completion of accounting processing.
